(19) United States
(12) Patent Application Publication
(10) Pub. No.: US 2026/0187581 A1
(43) Pub. Date: Jul. 2, 2026

(54) DISTRIBUTION CHANNEL SELECTION METHOD AND APPARATUS

(71) Applicant: GRABTAXI HOLDINGS PTE. LTD., Singapore (SG)

(72) Inventors: Kaican KANG, Singapore (SG); Albert VINSENSIUS, Singapore (SG); Yong LIU, Singapore (SG); Hendra Teja WIRAWAN, Singapore (SG)

(21) Appl. No.: 19/132,074

(22) PCT Filed: Sep. 12, 2023
(86) PCT No.: PCT/SG2023/050617

§ 371 Date: May 22, 2025

(30) Foreign Application Priority Data
Dec. 15, 2022 (SG) 10202260457Q

(51) Int. Cl. G06Q 10/0834

(52) U.S. Cl. CPC G06Q 10/08345

(57) ABSTRACT

The present disclosure provides distribution channel selection method and apparatus, the method comprising: calculating a distribution cost of each set of distribution channels of multiple sets of distribution channels to distribute products from multiple suppliers to multiple buyers, wherein at least one of the suppliers is set to distribute at least one of the products to each of the buyers in the each set of distribution channels; and adjusting the distribution cost of the each set of distribution channels based on one or more constraints, each constraint limiting a selection of a distribution channel for distributing one of the products from one of the suppliers to one of the buyers, wherein a set of distribution channels having a lowest distribution cost among the multiple sets of distribution channels is selected as an optimal set of distribution channels to distribute the products from the suppliers to the buyers.

### TECHNICAL FIELD

The present invention relates generally to distribution channel section method and apparatus, more particularly, the method and the apparatus are configured to select an optimal set of distribution channels to distribute products from multiple suppliers to multiple buyers.

### BACKGROUND

With increasing market competition that drives higher requirements for cost efficiency of supply chain, supply chain management (SCM) has become one of the most crucial focus areas in many businesses. Among the various supply chain (SC) optimization problems, distribution network optimization problem is a typical problem that significantly affects not only retailers' and their suppliers' cost structure, but also other connected processes (e.g. ordering, inventory replenishment) with direct consequences on product availability levels and consequently on end customer satisfaction. With this in mind, an optimized design of distribution channels and network is vital to business' success.

There are several types of distribution networks in the retail industry, where the main distribution networks include direct store delivery (DSD) network, or sometimes called decentralized distribution network, and centralized delivery/distribution network. In a centralized delivery network, the suppliers deliver their products to the retailers' warehouse or distribution center and from there, the retailers will deliver the products to respective retail stores by themselves. On the contrary, a DSD network is a type of retail distribution network where manufacturers or suppliers ship merchandise directly to their retailers by themselves or via their distributor. In the DSD model, products will bypass the retailer's warehouses or distribution centers. Both distribution networks have their own pros and cons and are associated with different delivery costs, time and other performance criteria such as reliability etc.

In a distribution network where retail stores (buyers) have the option to replenish from multiple suppliers or warehouses, it is an important and complex problem to know which distribution channels should the retailer select to fulfill requests of inventory replenishment as it has great impacts on the stores' overall SC cost. The problem becomes more complicated when multiple suppliers, retailers, and products are involved in the replenishment process, and the existing solutions are not able to solve large scale problems within a short period of time or not able to obtain solutions with good enough quality for various applications. Additionally, most of the existing solutions are restricted to very specific use cases and cannot address different requirements imposed by the users in various business contexts. In other words, they are not flexible enough in terms of problem modelling and solution design.

There is thus a need to devise a novel method and apparatus for selecting an optimal set of distribution channels to distribute one or more products from a plurality of suppliers to a plurality of buyers, more particularly, to improve operational efficiency, optimize supply chain cost, and achieve a balance between cost reduction and service improvement for the distribution of the products and replenishment decisions while addressing the pain points of the above existing solutions.

Furthermore, other desirable features and characteristics will become apparent from the subsequent detailed description and the appended claims, taken in conjunction with the accompanying drawings and this background of the disclosure.

### SUMMARY

In a first aspect, the present disclosure provides a method selecting an optimal set of distribution channels to distribute one or more products from a plurality of suppliers to a plurality of buyers, comprising: calculating, by a processor of an apparatus, a distribution cost of each set of distribution channels of a plurality of sets of distribution channels to distribute the one or more products from the plurality of suppliers to the plurality of buyers, wherein at least one of the plurality of suppliers is set to distribute at least one of the one or more products to each of the plurality of buyers in the each set of distribution channels of the plurality of sets of distribution channels; and adjusting, by the processor, the distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest distribution cost among the plurality of sets of distribution channels is selected as the optimal set of distribution channels to distribute the one or more products from the plurality of suppliers to the plurality of buyers.

In a second aspect, the present disclosure provides a system for selecting an optimal set of distribution channels to distribute one or more products from a plurality of suppliers to a plurality of buyers, comprising: at least one processor; and at least one memory including computer program code; the at least one memory and the computer program code configured to, with at least one processor, cause the server at least to, comprising: calculate a distribution cost of each set of distribution channels of a plurality of sets of distribution channels to distribute the one or more products from the plurality of suppliers to the plurality of buyers, wherein at least one of the plurality of suppliers is set to distribute at least one of the one or more products to each of the plurality of buyers in the each set of distribution channels of the plurality of sets of distribution channels; and adjust the distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest distribution cost among the plurality of sets of distribution channels is selected as the optimal set of distribution channels to distribute the one or more products from the plurality of suppliers to the plurality of buyers.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 depicts a schematic diagram illustrating distribution channels between suppliers and buyers in a centralized delivery network and a decentralized distribution network.

FIG. 2 shows a block diagram illustrating a system for selecting an optimal set of distribution channels to distribute one or more products from a plurality of supplier to a plurality of buyers according to various embodiments of the present disclosure.

FIG. 3 shows a diagram illustrating an example distribute network.

FIG. 4 shows a block diagram illustrating various components of a system for selecting an optimal set of distribution channels to distribute one or more products from a plurality of supplier to a plurality of buyers according to an embodiment of the present disclosure.

FIG. 5 shows a flow chart illustrating a method for selecting an optimal set of distribution channels to distribute one or more products from a plurality of supplier to a plurality of buyers according to an embodiment of the present disclosure.

FIG. 6 shows a block diagram illustrating a distribution channel optimization model for selecting an optimal set of distribution channels to distribute one or more products from a plurality of suppliers to a plurality of buyers according to an embodiment of the present disclosure.

FIG. 7 shows a flowchart illustrating three different data processing functions implemented in a pre-processing module according to an embodiment of the present disclosure.

FIG. 8 shows a first example parallel solving process implemented by an optimization solver module to select an optimal set of distribution channels to distribute one or more products from a plurality of suppliers to a plurality of buyers.

FIG. 9 shows a second example parallel solving process implemented by an optimization solver module to select an optimal set of distribution channels to distribute one or more products from a plurality of suppliers to a plurality of buyers.

FIG. 10 shows a flowchart illustrating an input and an output of selecting an optimal set of distribution channels to distribute one or more products in a distribution network of three suppliers to four retail stores according to an embodiment of the present disclosure.

FIGS. 11 and 12 show a schematic diagram of a general purpose computer system upon which the coordination server of FIG. 2 can be practiced.

FIG. 13 shows an alternative computer device to implement the coordination server of FIG. 2.

FIG. 14 shows a schematic diagram of a general purpose computer system upon which the distribution channel selection server of FIG. 2 can be practiced.

FIG. 15 shows an alternative computer device to implement the distribution channel selection server of FIG. 2.

FIG. 16 shows a schematic diagram of a general purpose computer system upon which a combined coordination and distribution channel selection server of FIG. 1 can be practiced.

FIG. 17 shows an alternative computer device to implement a combined coordination and distribution channel selection server of FIG. 2.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of this invention to present a service request allocation system and method under lack of available service providers condition.

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such devices should not be interpreted as a representation by the present inventor(s) or the patent applicant that such devices in any way form part of the common general knowledge in the art.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

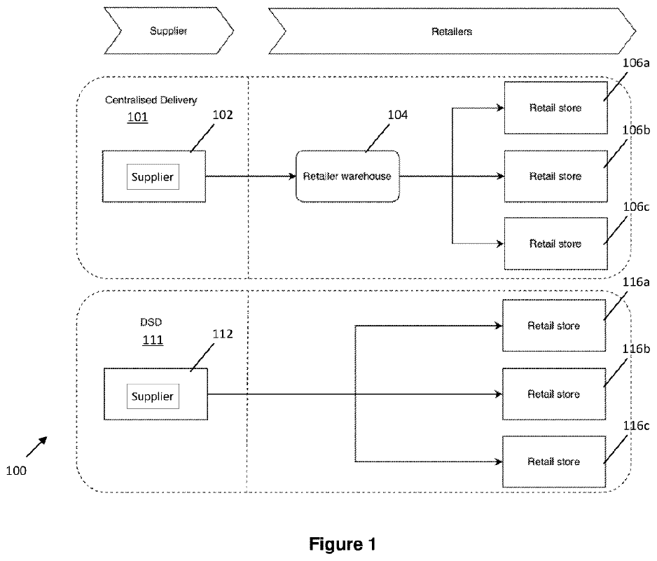

FIG. 1 depicts a schematic diagram 100 illustrating distribution channels between suppliers and buyers in a centralized delivery network 101 and a decentralized distribution network 111 such as direct store delivery (DSD) network, respectively. In centralized delivery network 100, when retailers with multiple retail stores 106a-106c purchase a product(s), a supplier 102 provides the product(s) to a retailers' warehouse 104 or distribution center (not shown). Subsequently, the retailers then deliver the product(s) to respective retail stores 106a-106c by themselves. On the other hand, in DSD network 111, when retailers with multiple retail stores 116a-116c purchase a product(s), a supplier 112 delivers the product(s) to the retail stores 116a-116c directly, bypassing the retailers' warehouse or distribution center.

As mentioned earlier, existing solutions are either not able to solve large scale problems within short period of time or not able to obtain solutions with good enough quality for various applications especially when multiple suppliers, retailers, and products are involved in the replenishment process. Additionally, most of the existing solution techniques are restricted to very specific use cases and cannot address different requirements imposed by the users in various business contexts. In other words, they are not flexible enough in terms of problem modeling and solution design.

For example, simulations have been carried out to explore replenishment mechanisms under scenarios of different parameters of customer arrival rate, inventory control policy, delivery cost, etc. Even though implications are provided regarding which mechanism performs better based on the simulation results, only a few number of scenarios are explored which may not be applicable in other contexts with different parameters. In addition, simulation running time is long although only one supplier is considered in the simplified network without multiple sourcing.

Simulation optimization techniques based on a Lagrangian relaxation-based heuristic has also been proposed. Although solutions with decent quality can be obtained within reasonable time, optimality is not guaranteed and the proposed method may not be appropriate in other problem settings without some specific assumptions.

Also, some existing models consider only delivery cost and reliability in the objective function. In addition, the models also allow partial and splitting replenishment, meaning retail stores belonging to the same retail chain can be served by different suppliers and the replenishment for a certain retailer may also be split across multiple suppliers, which could increase overhead costs for engaging different suppliers for replenishment. Non-partial and non-splitting replenishment, where retails stores belonging to the same retain chain can be served by only one supplier for the replenishment, was not considered in such models.

In this present disclosure, a network optimization model is able to decide which distribution and replenishment channels to use for retailers in the context of multiple suppliers, retail stores and product types, so as to minimize the overall SC costs that include delivery time, cost, reliability, etc. to achieve the best balance between cost reduction and service improvement for the distribution and replenishment decisions while addressing the pain points of the above existing solutions. More details are described in the following paragraphs.

In various embodiments of the present disclosure below, a product may refer to a good (or a merchandise) and/or a service. A buyer (herein may referred to as “requestor”) is a person, consumer, company or entity who requests for the good and/or service and creates a request order (herein may referred to as “product order”, “purchase order” or “order request”), whereas a supplier (herein may referred to as “provider”) is a person, company or entity who provides the good and/or service for purchase by the buyer, or a third party who is associated with, assists or acts on behalf of such person, distributor, company or entity to provides the good and/or service for purchase by the buyer. A distribution channel refers to a mode of distributing a product ordered by a buyer and fulfilling whole or a part of a request order of a buyer, by connecting a buyer to a supplier among a network of suppliers and buyers.

A set of distribution channel is a combination of distribution channels required to distribute of one or more products from one or more suppliers and one or more buyers, where applicable in order to fulfil the existing request orders. For example, where multiple suppliers and buyers requesting for different products are involved, different supplier-buyer combinations and arrangements can be possibly used, thereby resulting in different possible sets of distribution channels (herein may referred to as “a plurality sets of distribution channels”) to distribute the same products from the same suppliers and same buyers and fulfil same requests orders. For example, products requested by a buyer A can be distributed by a supplier A, a supplier B or both (i.e., three different distribution channels), thereby resulting in at least three different sets of distribution channels (when combined with other distribution channels to fulfil other request orders). In various embodiments below, the term “set of distribution channel” may be referred to as “solution” to the supply chain and product distribution problem.

In various embodiments, using a common solution algorithm or model which utilizes a set of data relating to the products, suppliers and buyers from data input, a distribution cost of each set of distribution channels of a plurality of sets of distribution channels can be calculated, and such distribution costs of the different sets of distribution channels among the plurality of sets of distribution channels are compared and used to select the optimal set of distribution channels (e.g., the set of distribution channels having the lowest distribution cost) among the plurality of sets of distribution channels to be used to distribute the products from the suppliers and the buyers.

In an embodiment, different (second) solution algorithm or model which utilizes a different set of data (e.g., with additional or reduced data) relating to the products, suppliers and buyers from the data input may be used to calculate a different distribution cost. Such different set of data may correspond to additional suppliers, buyers and/or products (e.g., when brute force search is then applied) or reduced number of suppliers, buyers and/or products (e.g., when metaheuristics model is then applied such as general algorithm (GA), simulated annealing (SA), tabu search (TS), ant colony system (ACS)), and, in such case, result in a different (second) set of distribution channel, and thus a different (second) plurality of sets of distribution channels, required to distribute to fulfil the request orders with the additional/reduced number of suppliers, buyers and/or product with a different distribution cost.

In various embodiments of the present disclosure, a constraint which may limit a selection of a distribution channel to distribute a product and fulfil a request order is taken in account in the selection of the optimal sets of distribution channels, for example, by adjusting the calculated distribution costs based on the constraint and its imposed limitation. Such constraint may be related to a specific supplier, buyer, product, order (e.g., order sizes, quantity), or a combination thereof. Examples of a constraint includes, but not limited to, an available mode of delivery, a preferred mode of delivery, an exclusive mode of delivery, an available time of delivery, a preferred time of delivery, an exclusive time of delivery, a preferred supplier, an exclusive supplier, an availability of supplier, a preferred buyer, an exclusive buyer, an availability of buyer, a number of suppliers to fulfil an order request, a minimum order requirement, a delivery capacity, a product handling requirement, a sequence of delivery or any other constraint that would cause a distribution channel be less favourable to be selected to distribute a product from a supplier to a buyer and fulfil a product order request.

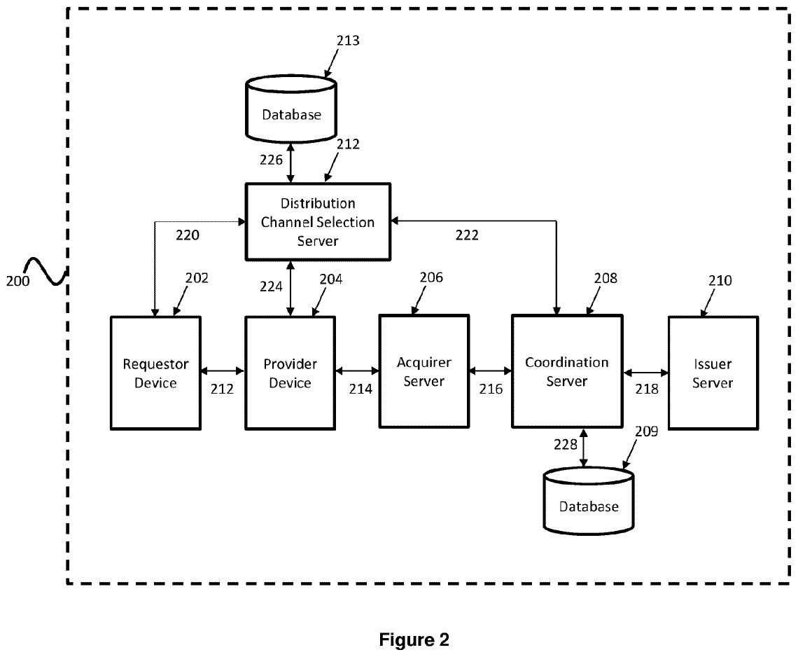

According to various embodiments of the present disclosure, the process of selecting a set of distribution channels can implemented through a system. FIG. 2 shows a block diagram illustrating a system 200 for selecting an optimal set of distribution channels to distribute one or more products according to an embodiment. Further, the system 200 may enable a transaction for a product(s), and/or a request for a product(s) between a requestor and a provider (herein may referred to as “users”). Herein in this embodiment, a product refers to a good, a service or a combination thereof; and a request for a product of the provider from the requestor may be referred to as a coordination request or a transaction request.

The system comprises a requestor device 202, a provider device 204, an acquirer server 206, a coordination server 208, an issuer server 210 and a distribution channel set selection server 212.

A user may be any suitable type of entity, which may include a consumer, company, corporation or governmental entity (i.e., requestor) who looking to request for a product via a coordination server 208, or an application developer, company, corporation or governmental entity (i.e., provider) who looking to sell or provide a product via the coordination server 208.

A requestor device 202 is associated with a buyer (or requestor) who is a party to, for example, a request for a product that occurs between the requestor device 202 and the provider device 204. The requestor device 202 may be a computing device such as a desktop computer, an interactive voice response (IVR) system, a smartphone, a laptop computer, a personal digital assistant computer (PDA), a mobile computer, a tablet computer, and the like.

The requestor device 202 may include user credentials (e.g., a user account) of a requestor to enable the requestor device 202 to be a party to a transaction. If the requestor has a user account, the user account may also be included (i.e., stored) in the requestor device 202. For example, a mobile device (which is a requestor device 202) may have the user account of the customer stored in the mobile device.

In one example arrangement, the requestor device 202 is a computing device in the form of a watch or similar wearable and is fitted with a wireless communications interface (e.g., an NFC interface). The requestor device 202 can then electronically communicate with the provider device 204 regarding a transaction or coordination request. The customer uses the watch or similar wearable to make a request regarding the transaction or coordination by pressing a button on the watch or wearable.

A provider device 204 is associated with a provider who is also a party to the request for a good or service that occurs between the requestor device 202 and the provider device 204. The provider device 202 may be a computing device such as a desktop computer, an interactive voice response (IVR) system, a smartphone, a laptop computer, a personal digital assistant computer (PDA), a mobile computer, a tablet computer, and the like. Hereinafter, the term “provider” refers to a product provider and any third party associated with providing a product for purchase via the provider device 204. Therefore, the user account of a provider refers to both the user account of a provider and the user account of a third party (e.g., a route coordinator) associated with the provider.

If the provider has a user account, details of the user account may also be included (i.e., stored) in the provider device 204. For example, a mobile device (which is a provider device 204) may have user account details (e.g., account number) of the provider stored in the mobile device.

In one example arrangement, the provider device 204 is a computing device in the form of a watch or similar wearable and is fitted with a wireless communications interface (e.g., an NFC interface). The provider device 204 can then electronically communicate with the requestor to make a request regarding the transaction or coordination request by pressing a button on the watch or wearable.

An acquirer server 206 is associated with an acquirer who may be an entity (e.g. a company or organization) which issues (e.g. establishes, manages, administers) a payment account (e.g. a financial bank account) of a merchant (e.g., provider). An example of an acquirer is a bank or other financial institution. As discussed above, the acquirer server 206 may include one or more computing devices that are used to establish communication with another server (e.g., the coordination server 208) by exchanging messages with and/or passing information to the other server. The acquirer server 206 forwards the payment transaction relating to a transaction or order request to the coordination server 208.

A coordination server 208 is configured to carry out processes relating to a user account by, for example, forwarding data and information associated with the transaction to the other servers in the system 200, such as the distribution channel selection server 212. In an example, the coordination server 208 may provide location data, route data, time data, product data, order data, requestor data, provider data and transaction data associated with a request that may be used for the optimal distribution channels set selection processes by the distribution channel selection server 212. An image or a list may be determined based on an outcome of the optimal distribution channels set selection process e.g., a list of requests from different requestors to be fulfilled by different providers.

An issuer server 210 is associated with an issuer and may include one or more computing devices that are used to perform a payment transaction. The issuer may be an entity (e.g., a company or organization) which issues (e.g., establishes, manages, administers) a transaction credential or a payment account (e.g., a financial bank account) associated with the owner of the requestor device 202. As discussed above, the issuer server 210 may include one or more computing devices that are used to establish communication with another server (e.g., the coordination server 208 by exchanging messages with and/or passing information to the other server.

The coordination server 208 may be a server that hosts software application programs for processing transaction or coordination requests, for example, requests of products by users. The coordination server 208 may also be configured for processing coordination requests between a requestor and a provider. The coordination server communicates with other servers (e.g., distribution channel selection server 212) concerning transaction or coordination requests. The coordination server 108 may communicate with the distribution channel selection server 212 to facilitate selection of an optimal set of distribution channels to distribute one or more products from multiple providers to multiple requestors associated with the transaction or coordination requests. The coordination server 208 may use a variety of different protocols and procedures in order to process the transaction or coordination requests.

In an example, the coordination server 208 may receive from one user device (such as the requestor device 212 or the provider device 214) location data, route data, time data, product data, order data, requestor data, provider data and transaction data associated with a request including one or more constraints which would limit a selection of one or more distribution channels and provide the data to the distribution channel selection server 212 for use in the optimal distribution channels set selection processes.

Additionally, transactions that may be performed via the coordination server include good or service purchases, credit purchases, debit transactions, fund transfers, account withdrawals, etc. Coordination servers may be configured to process transactions via cash-substitutes, which may include payment cards, letters of credit, checks, payment accounts, tokens, etc.

The coordination server 208 is usually managed by a service provider that may be an entity (e.g. a company or organization) which operates to process transaction or coordination requests. The coordination server 208 may include one or more computing devices that are used for processing transaction or coordination requests.

A user account may be an account of a user who is registered at the coordination server 208. The user can be a customer, a good or a service provider (e.g., a product supplier, a distributor, a delivery service provider), or any third parties (e.g., a map/route planner, order coordinator) who want to use the coordination server. A user who is registered to a coordination server 208 or a distribution channel selection server 212 will be called a registered user. A user who is not registered to the coordination server 208 or distribution channel selection server 212 will be called a non-registered user.

The coordination server 208 may also be configured to manage the registration of users. A registered user has a user account which includes details and data of the user. The registration step is called on-boarding. A user may use either the requestor device 202 or the provider device 204 to perform on-boarding to the coordination server 208.

The on-boarding process for a user is performed by the user through one of the requestor device 202 or the provider device 204. In one arrangement, the user downloads an app (which includes, or otherwise provides access to, the API to interact with the coordination server 208) to the requestor device 202 or the provider device 204. In another arrangement, the user accesses a website (which includes, or otherwise provides access to, the API to interact with the coordination server 208) on the requestor device 202 or the provider device 204. The user is then able to interact with the distribution channel selection server 212. The user may be a requestor or a provider associated with the requestor device 202 or the provider device 204, respectively.

Details of the registration include, for example, name of the user, address of the user, emergency contact, next-of-kin contact, a consent to retrieve data and information from the requestor device 202 and/or the provider device 204. Alternatively, another mobile device may be selected instead of the requestor device 202 and/or the provider device 204 for retrieving the details/data. Once on-boarded, the user would have a user account that stores all the details/data.

It may not be necessary to have a user account at the coordination server 108 to access the functionalities of the coordination server 208. However, there may be functions that are available only to a registered user for example the provision of including order data indicating a constraint to be applied when distributing a product. The term “user” will be used to collectively refer to both registered and non-registered users. A user may interchangeably be referred to as a requestor (e.g. a person who purchases a good or a service and creates a purchase order) or a provider (e.g. a person who provides the good or the service to fulfil the purchase order).

The coordination server 208 may be configured to communicate with, or may include, a database 209 via connection 228. The connection 228 may be over a network (e.g., a local area network, a wide area network, the Internet, etc.). The database 209 stores user details/data as well as data corresponding to a transaction (or transaction data). Examples of the transaction data include Transaction identifier (ID), Merchant (Provider) ID, Merchant Name, MCC/Industry Code, Industry Description, Merchant Country, Merchant Address, Merchant Postal Code, Aggregate Merchant ID. For example, data (“Merchant name” or “Merchant ID”) relating to the merchant/provider, time and date relating to the transaction of goods/services.

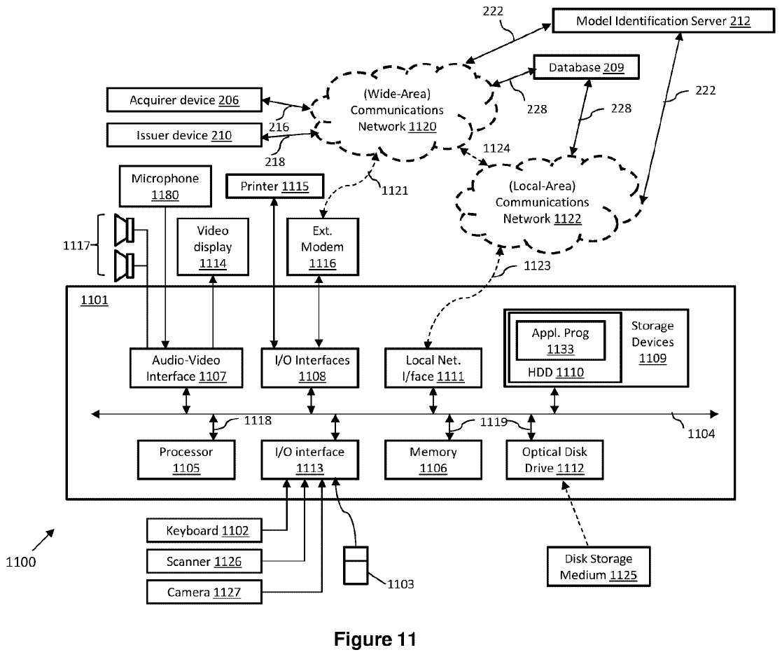

A distribution channel selection server 212 may be a server that hosts distribution cost calculation and channel selection software application programs for selecting an optimal set of distribution channels to distribute one or more products from one or more suppliers to one or more buyers. In one example, the distribution channel selection server 212 may obtain data relating to different suppliers, buyers and products, for example in the form of order requests, from a user device (such as the requestor device 212 or the provider device 214) or a database 209 in connection with the coordination server 208, and use the data for selecting an optimal set of distribution channels to distribute the different products from the suppliers to the buyers. The distribution channel selection server 212 may be implemented as shown in FIGS. 11, 14 and 16.

The database 209 stores location data, route data, time data, product data, order data, requestor data, provider data and transaction data obtained, for example in the form of order requests from a user device (such as the requestor device 212 or the provider device 214.

The location data may be geo-tagged with a geographical coordinate (e.g. latitudinal and longitudinal coordinates) and map-matched to locate a location using location coordinates. In an example, the database 209 may be a database managed by an external entity and the database 209 is a server that, based on a request received from a user device (such as the requestor device 212 or the provider device 214) or the coordination server 208, retrieve location data, route data, time data, product data, order data, requestor data, provider data and transaction data associated with the request and transmit the data to the user device or the coordination server 208. Alternatively, a module such as a coordination module may store the data instead of the database 209, wherein the module may be integrated as part of the coordination server 208, or may be external to the coordination server 208.

The database 213 may store parameters (e.g., pre-set weightage parameters to be applied to different types of data) and computer programs used by each solution algorithm to output a plurality of sets of distribution channels to distribute the products from the suppliers and the buyers.

Use of the term ‘server’ herein can mean a single computing device or a plurality of interconnected computing devices which operate together to perform a particular function. That is, the server may be contained within a single hardware unit or be distributed among several or many different hardware units.

The requestor device 202 is in communication with the provider device 204 via a connection 212. The connection 2 may be an ad hoc connection (e.g., via NFC communication, Bluetooth, etc.) or over a network (e.g., the Internet). The requestor device 202 is also in communication with the distribution channel selection server 212 via a connection 220. The connections 212, 220 may be a network connection (e.g., the Internet). The requestor device 202 may also be connected to a cloud that facilitates the system 200 for selecting an optimal set of distribution channel to distribute one or more products from suppliers to buyers. For example, the requestor device 202 can send a signal or data to the cloud directly via an ad hoc connection (e.g., via NFC communication, Bluetooth, etc.) or over a network (e.g., the Internet).

The provider device 204 is in communication with the requestor device 212 as described above, usually via the coordination server 208. The provider device 204 is, in turn, in communication with the acquirer server 106 via a connection 214. The provider device 204 is also in communication with the distribution channel selection server 212 via a connection 224. The connections 214 and 224 may be network connections (e.g., provided via the Internet). The provider device 204 may also be connected to a cloud that facilitates the system 200 for selecting an optimal set of distribution channel to distribute one or more products from suppliers to buyers. For example, the provider device 204 can send a signal or data to the cloud directly via an ad hoc connection (e.g., via NFC communication, Bluetooth, etc.) or over a network (e.g., the Internet).

The acquirer server 206, in turn, is in communication with the coordination server 208 via a connection 216. The coordination server 208, in turn, is in communication with an issuer server 210 via a connection 218. The connections 216 and 218 may be over a network (e.g., the Internet).

The coordination server 208 is further in communication with the distribution channel selection server 212 via a connection 222. The connection 222 may be over a network (e.g., a local area network, a wide area network, the Internet, etc.). In one arrangement, the coordination server 208 and the distribution channel selection server 212 are combined and the connection 222 may be an interconnected bus.

The distribution channel selection server 212, in turn, is in communication with a database 213 via a connection 226. The connection 226 may be a network connection (e.g., provided via the Internet). The distribution channel selection server 212 may also be connected to a cloud that facilitates the system 200 for selecting an optimal set of distribution channels to distribute one or more products from suppliers to buyers. For example, the distribution channel selection server 212 can send a signal or data to the cloud directly via a wireless ad hoc connection (e.g., via NFC communication, Bluetooth, etc.) or over a network (e.g., the Internet).

In the illustrative embodiment, each of the devices 202, 204, and the servers 206, 208, 210, 212 provides an interface to enable communication with other connected devices 202, 204 and/or servers 206, 208, 210, 212. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof. Examples of APIs include the REST API, and the like. For example, it is possible for at least one of the requestor device 202 and the provider device 204 to receive or submit a request to select an optimal set of distribution channels to distribute one or more products from suppliers to buyers in response to an enquiry shown on the GUI running on the respective API.

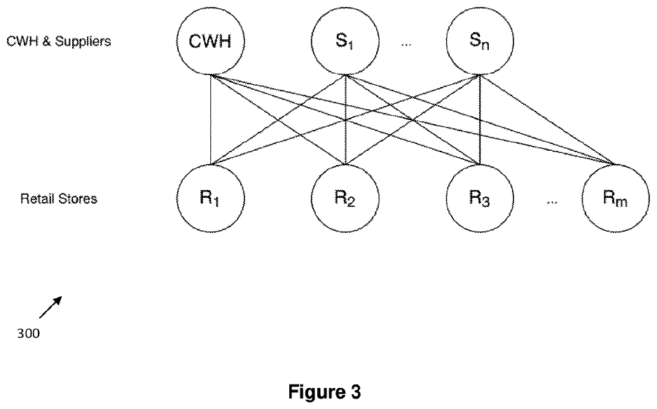

FIG. 3 shows a diagram illustrating an example distribution network 300. The distribution network 300 corresponds to a possible set of distribution channels with a combination of 12 distribution channels connecting suppliers (e.g., central warehouse (CWH), supplier 1 S₁, . . . , supplier n Sₙ) and retail stores (e.g., R₁, R₂, R₃, . . . , Rₘ) to distribute products from the suppliers to the retail stores and fulfil order requests of the retail stores. It is appreciated that different combination of distribution channels (e.g., without some of the connections between the suppliers and retail stores), which corresponds to a different set of distribution channels, can also be possibly used to distribute products from the suppliers to the retail stores and fulfil order requests of the retail stores.

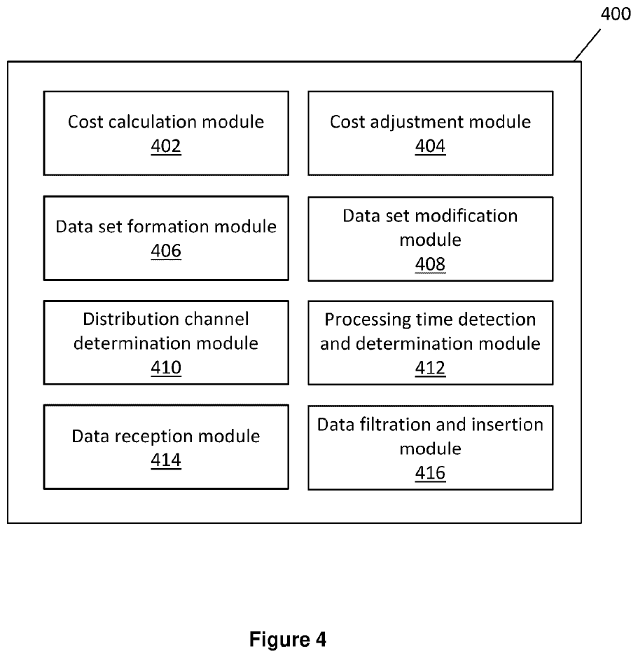

FIG. 4 shows a block diagram illustrating various components of an apparatus 400 for selecting an optimal set of distribution channels to distribute one or more products from a plurality of suppliers to a plurality of buyers according to an embodiment of the present disclosure. The apparatus 400 may comprise a cost calculation module 402, a cost adjustment 404, a data set formation module 406, a data set modification module 408, a distribution channel determination module 410, a processing time detection and determination module 412, a data reception module 414 and a data filtration and insertion module 318. In an alternative embodiment, such components or modules are comprised on, or implemented as part of, a processor of the apparatus 400.

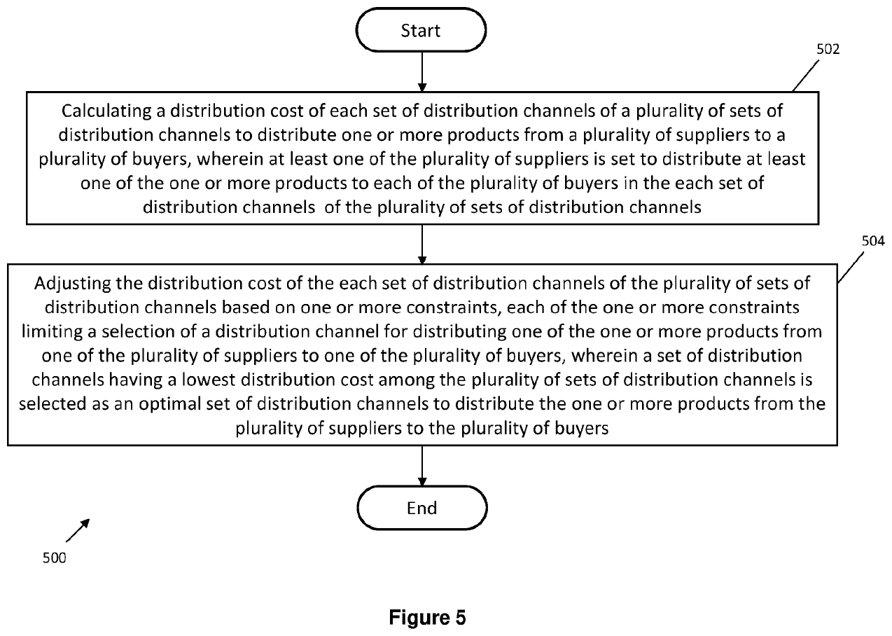

As shown in the exemplified method for selecting an optimal set of distribution channels to distribute one or more products from a plurality of suppliers to a plurality of buyers in FIG. 5, the apparatus 400 or a processor of the apparatus 400, when in operation, is configured to perform the following steps:
step 502: calculating a distribution cost of each set of distribution channels of a plurality of sets of distribution channels to distribute one or more products from the plurality of suppliers to the plurality of buyers, wherein at least one of the plurality of suppliers is set to distribute at least one of the one or more products to each of the plurality of buyers in the each set of distribution channels of the plurality of sets of distribution channels; and
step 504: adjusting the distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest distribution cost among the plurality of sets of distribution channels is selected as an optimal set of distribution channels to distribute the one or more products from the plurality of suppliers to the plurality of buyers.

The cost calculation module 402 is configured to perform step 502 while the cost adjustment module 404 is configured to perform step 504.

In step 502, the data set formation module 406 may be configured to form a set of data relating to the one or more products, the plurality of buyers and/or the plurality of suppliers received from the data input, and the cost calculation module 402 may be configured to calculate the distribution cost of the each set of distribution channels of the plurality of sets of distribution channels to distribute the one or more products from the plurality of suppliers to the plurality of buyers. The data reception module 414 may be configured to receive data as data input. The data received by the data reception module 414 as data input may relate to a product quantity, a distribution cost of a buyer and/or a supplier, a location, a required delivery time, a distance, a reliability level of a buyer and/or a supplier. Additionally, the data may further include a weight parameter to be applied to each such data.

Alternatively and additionally, in step 504, the data filtration and insertion module 416 may be configured to detect data relating to a human input error or a false measurement from the data received by the data reception module 414, and filter out such data relating to the human input error or the false measurement from the data input. The data set formation module 406 may be configured to form the set of data relating to the one or more products, the plurality of buyers and/or the plurality of suppliers from the data input filtered by the data filtration and insertion module 416.

Alternatively and additionally, in step 504, the data filtration and insertion module 416 may be configured to detect missing data in the data received by the data reception module 414, and insert new data to replace or fill up the missing data in the data input. The data set formation module 406 may be configured to form the set of data relating to the one or more products, the plurality of buyers and/or the plurality of suppliers from the data input with the new data inserted by the data filtration and insertion module 416. Such new data can be a pre-set data, like value “0”, or a median or average value of existing data of the same type in the data input.

The data set modification module 408 may be configured to modify the set of data formed by the data set formation module 406, for example, data within the set of data relating to at least one of the one or more products, at least one of the plurality of buyers and/or at least one of the plurality of suppliers based on the one or more constraints. The cost calculation module 402 or the cost adjustment module 404 may be configured to then calculate the distribution cost in step 502 based on the modified set of data.

In step 504, the distribution channel determination module 410 may be configured to determine if a distribution channel of the each set of distribution channels is a distribution channel which selection is limited by the one or more constraints. The cost adjustment module 404 may be configured to adjust the distribution cost in response to a result of the determination by the distribution channel determination module 410.

Additionally or alternatively, the cost calculation module 402 is configured to calculate a second distribution cost of each second set of distribution channels of a plurality of second sets of distribution channels to distribute the one or more products from the plurality of suppliers to the plurality of buyers, for example, based on a different algorithm/model or different set of data (e.g., weight parameter of the data) relating to the one or more products, the plurality of buyers and/or the plurality of suppliers formed by the data input. The cost adjustment module may be configured to adjust the second distribution cost based on the one or more constraints.

The apparatus 400, or the processor of the apparatus 400, may further comprises a distribution channel selection module (not shown) to select a set of distribution channel having the lowest distribution cost from the plurality of sets of distribution channels and, where applicable, the plurality of second sets of distribution channels, as the optimal set of distribution channels to distribute the one or more products from the plurality of suppliers to the plurality of buyers after step 504.

Additionally or alternatively, the processing time detection and determination module 412 may be configured to detect that a processing time for calculating and adjusting the respective distribution costs of the plurality of sets of distribution channels has exceeded a first pre-configured processing time limit, and in response to such detection, the selection of the set of distribution channel having the lowest distribution cost from the plurality of sets of distribution channels, as the optimal set of distribution channels, to distribute the one or more products from the plurality of suppliers to the plurality of buyers is then carried out, for example, by the distribution channel selection module.

Additionally or alternatively, the processing time detection and determination module 412 may be configured to determine if a processing time for calculating and adjusting the respective distribution costs of the plurality of sets of distribution channels has exceeded a second pre-configured processing time limit, and in response to such determination, the cost calculation module 402 and the cost adjustment module 404, may be configured to calculate and adjust a further distribution cost of the each set of distribution channels of the plurality of sets of distribution channels to distribute the one or more products from the plurality of suppliers to the plurality of buyers. In such case, the selection of the set of distribution channel having the lowest further distribution cost from the plurality of sets of distribution channels, as the optimal set of distribution channels, to distribute the one or more products from the plurality of suppliers to the plurality of buyers is then carried out, for example, by the distribution channel selection module.

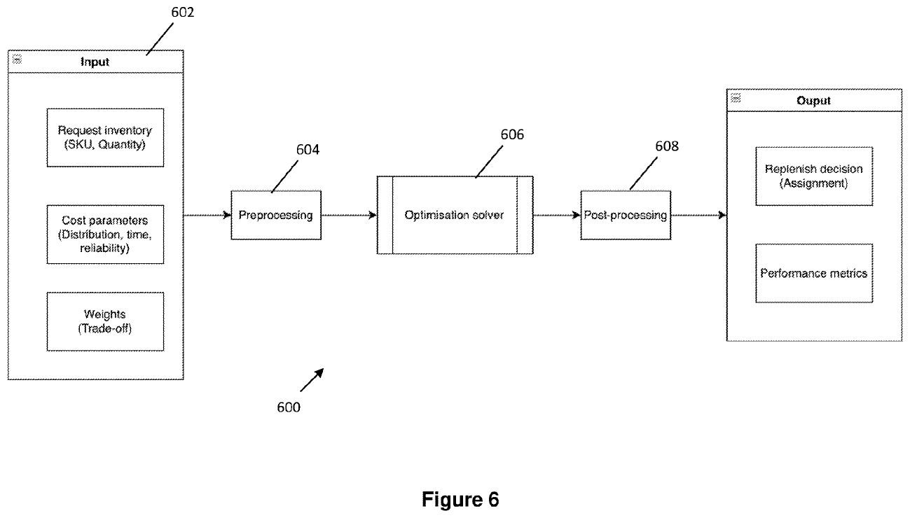

FIG. 6 shows a block diagram illustrating a distribution channel optimization model 600 for selecting an optimal set of distribution channels to distribute one or more products from a plurality of suppliers to a plurality of buyers according to an embodiment of the present disclosure. The distribution channel optimization model consists of three main modules: a pre-processing module 602, an optimisation solver module 604 and a post-processing module 606.

### Pre-Processing Module 602

The pre-processing module 602 is used to take raw data from user input and perform the required data processing that includes cleaning, treatment and transformation. It's responsible for ensuring data quality such that they can be consumed by the network optimization solver.

In particular, the pre-processing module 602 takes raw data from data input 602, for example, user input, and processes the data into a format that can be used by the optimisation solver module 606. To begin with, data such as requested products, quantity, weightage parameters (or weight, trade-off), cost of distribution, delivery time, reliability level, etc. are provided from the data input 602, for example, in the form of a template data file of plain text or excel format. The file will then be read by the model 600 to process with a number of data processing functions implemented in the module.

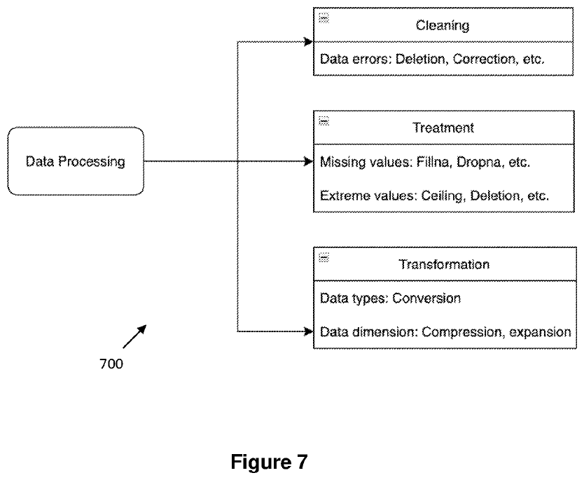

FIG. 7 shows a flowchart 700 illustrating three different data processing functions implemented in a pre-processing module 606 according to an embodiment of the present disclosure. One data cleaning function may also include detecting data errors resulting from human input error or false measurement. These data errors will be filtered out for deletion, correction. In addition, as it is not uncommon to see missing data in the data source, another data cleaning function may include several data treatment functions that help to insert and populate those missing data and values by all kinds of techniques applicable such as Fillna, Dropna, ceiling and deletion. For example, some missing values are simply replaced by zero (value “0”), ceiling value, some by median or by mean values on a case by case basis. Lastly, some custom data transformation functions are implemented to extract the raw data from source files and transform them, for example, through compression or expansion, into formats specified by the optimization solver module 606. The delivery time, distance or cost matrices for the network optimization problem can be easily obtained with help of those data transformation functions.

For example, the pre-processing 604 will form set of data relating to one or more products, suppliers and buyers from the data input 602, which will be used optimization solver 606 to select optimal distribution channels to distribute the products.

### Optimization Solver Module 606

The optimization solver module 606 is equipped with a set of solution algorithms that take the input data from the pre-processing module 604 and perform the computation and optimization to obtain the optimal solutions (set of distribution channels) that help to make economically sensible decisions regarding the distribution network configuration. In addition, some feasibility correction and adjustment operators are implemented in the optimization solver module 606 to ensure that all business requirements and constraints are satisfied during the search for optimal solutions. It is also worth mentioning that solution algorithms are utilized simultaneously for problem solving with the help of parallel solver pipelines and only the best solution will be returned to the users.

The optimisation solver module 606 comprises objective function unit, feasibility correction and adjustment operator unit for constraint handling and solution algorithms unit.

The function of the objective function unit may correspond to that of the cost calculation module 402 in FIG. 4, which is to perform objective function modelling and distribution cost calculation.

It is noted that different weight parameters (or weight, trade-off) may be provided from the data input 602, for example, by the user. The weight parameters are to be applied to other input data such that different evaluation criteria or metrics such as delivery cost, time, supplier reliability or any criteria that are appropriate for current use cases are considered and given more priority and weightage in the distribution cost calculation Trade-off between those performance criteria needs to be made such that the overall distribution cost is optimized (minimized).

The objective function for the optimization problem is formulated according to equation (1) below.

$$Overall cost = {{w}_{1}}^{*} Cost + {{w}_{2}}^{*} Time + {{w}_{3}}^{*} Reliability + … + {{w}_{n}}^{*} {Criterion}_{n} \qquad equation ( 1 )$$

The introduction of weightage parameters provides users much better control over the cost structure that fits their use cases best. For example, during sale or promotion seasons, the retailers might want to shorten the delivery time and require higher supplier service level so that they can satisfy more customer demands and thus improve retention, repurchase, and revenue. In this case, the users can put more weights on time and reliability and less weights on cost.

Another thing to note is that since these metrics have different units of measurement, scaling treatment is needed so that they are comparable in the objective function. Here we use min-max scaling. All the metrics will be recalculated using equation (2) below.

$${Metric}_{new} = {Metric}_{original} / ( {Metric}_{original \_ max} - {Metric}_{original \_ min} ) \qquad equation ( 2 )$$

In other words, the original metrics in the objective function will be divided by the magnitude of their variation range respectively.

The model 600 is very flexible in terms of the constraint modeling and handling. Common constraints such as capacity, minimum order quantity (MOQ), availability, demand and supply equality can be easily modeled and handled in the optimization solver 606. It can also handle other constraints like non-splitting or non-partial replenishment. These constraints can be handled in the solver with the help of feasibility correction and adjustment operators. During the solution search, feasibility correction operators will be used if it's easy to do the correction operations on the candidate solution like addition, subtraction, or rounding to zero to ensure constraint feasibility. In other words, the feasibility correction operators may determine if a distribution channel which selection will be limited by a constraint and modify the set of data (e.g., addition, subtraction or rounding the value to zero) to calculate, adjust or recalculate the distribution cost of a distribution channel(s).

For example, when handling the availability constraint, the suppliers that are not selected for inventory replenishment, there shouldn't be any inventories supplied from these suppliers. Therefore, the feasibility correction operator can be used to zero out the corresponding inventory supplies in the solutions. Similarly, for solutions that violate non-splitting or non-partial replenishment constraints, the required inventory from certain retail stores will be assigned fully to a certain supplier and zero out the inventory supply from the rest of suppliers. For solutions that violate other constraints like capacity and MOQ constraints, simple correction operators are not applicable. In such cases, feasibility adjustment operators will be applied such that certain penalty costs are factored into the objective function. In other words, those constraints will be treated as soft constraints. Solutions that incur those penalties are less favorable and less likely to be selected as the candidates during the search of optimal solutions. Take the capacity constraint as an example, if a solution violates the capacity constraints, then the penalty cost incurred due to the exceeded loads will be calculated as a proportion of total costs in the objective function.

In the optimization solver module 606, several solution algorithms/models are explored to solve the optimization problem. Specifically, brute force search and metaheuristics, such as GA, SA, TS, Ant Colony System (ACS), Particle Swarm Optimisation (PSO), are implemented in the optimization solver module 606. These solution algorithms/models will be applied under different problem settings. For problems with small size, it is advisable to use brute force search since global optimum can be obtained and the computation time is affordable. While for large-scale problems, the metaheuristics are more appropriate since they are capable of producing near-optimal solutions within a short period of solving time. However, these metaheuristics have different advantages and disadvantages and are preferable in different problem contexts. Therefore, to ensure the solution quality, parallel solver pipeline is implemented. This means that when solving the above network optimization problem, at least two solution algorithms/models (e.g., multiple metaheuristics models) will be applied concurrently with the help of a parallel solver pipeline. Each solution algorithm/model will generate multiple candidate solutions (possible sets of distribution channels), each having a distribution cost. The best solution (optimal set of distribution channels), for example, having the lowest distribution cost, among all the candidate solutions, will be returned to the users so that we are able to ensure decent solution quality irrespective of different problem contexts and use cases.

The model 600 supports two approaches for parallel solving. The implementation details of the parallel solver pipeline are provided as follows.

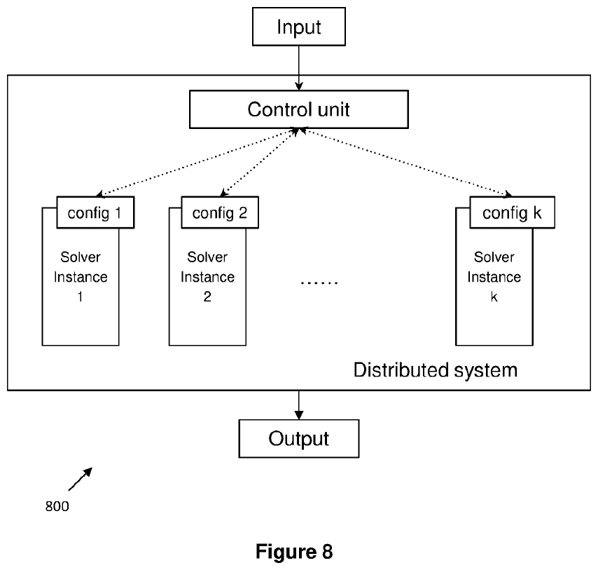

FIG. 8 shows a first example parallel solving process 800 implemented by an optimization solver module to select an optimal set of distribution channels to distribute one or more products from a plurality of suppliers to a plurality of buyers. The first example parallel solving process deploys the optimization solver module 606 on a distributed computation infrastructure. The optimization solver module 606 itself is represented as three components:
1. The input to describe the problem, that is generic and can be used for any solution algorithms, such as GA, SA, TS, ACS, PSO, etc.
2. A config file, that specifies the solution algorithm to use, the solving time upper bound that represents the maximum running time of the solution algorithm, and other parameters required by the algorithm itself.
3. The solution output is defined in the same format across all the algorithms.

This process requires a distributed system and a simple control flow implementation in the control unit of the distributed system, which handles the data parsing and the output collection. The solver itself can be executed on a single-core CPU instance. The parallel solving can be achieved with multiple such instances.

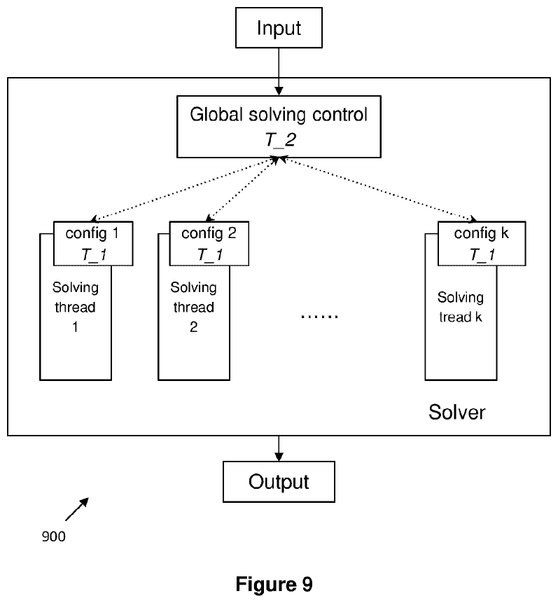

FIG. 9 shows a second example parallel solving process 900 implemented by an optimization solver module to select an optimal set of distribution channels to distribute one or more products from a plurality of suppliers to a plurality of buyers. The second example parallel solving process implements the parallel computation inside the optimization solver module 606. The optimization solver module 606 itself handles the parallel computation with following steps:
1. Read the input and config files. The input is the problem description. The config files specify the list of solution algorithm candidates.
2. Start the parallel computation using threads to solve the problem with different algorithms. A first solving time upper bound T_1 will be configured upfront or preconfigured so that all the algorithms will be run with the same solving time. T_1 denotes the pre-configured solving time limit. In other words, the solution candidates of each solution algorithm will be output after, or upon detecting, the processing time of the algorithm has reached or exceeded T_1.
3. Collect the solution outputs from all the algorithms after the T_1 limit is reached or the individual algorithm returns the solution. Then the solver selects the best solution among all the solution candidates returned and checks a second solving time upper bound T_2 has reached. If the processing time of the algorithms has not reached T_2 time limit, it repeats from step 2 to calculate a further solution (further distribution cost). Otherwise, it continues to the next step.
4. Package the best solution (having the lowest distribution cost or lowest further distribution cost where applicable) from parallel computation, and return the final solution as output.

It is noted, in the config, T_2 >T_1, or T_2=n*T_1. Here, n may be configured to have at least a number of iterations (step 2) of parallel computation executed and further solutions (distribution costs) output before the best solution is selected.

### Post-Processing Module 608

The post-processing module takes the solution outputs produced by the optimization solver module 606 and translates them into a format that can be easily understood and applied by the user.

The outputs produced by the optimization solver module 606 are used as input for the post-processing module 608 for further processing. An important function of the post-processing module is to calculate the performance metrics that are required for detailed cost analysis or performance comparison. For example, the user might want to know the cost composition resulting from the final solution, how much costs are incurred from delivery reliability issues, how much delivery time or cost will be spent for the replenishment, etc. The information is helpful and can be used to further investigate and improve the operational process, for example, to adjust weight parameter to be applied to the data input, and thus reduce the overall cost upfront or output better and more accurate distribution cost.

The post-processing module is also responsible for solution transformation. The solution is originally represented by suppliers' index number which is easy and simple to use by the optimization solver during the solution search process. However, it may not be easily understood and applied by the user. Therefore, the transformation is required to convert the solutions into a format for ease of application. The final solutions together with required performance metrics will then be provided in an output file of plain text or csv format that can be directly used by operation personnels on the ground.

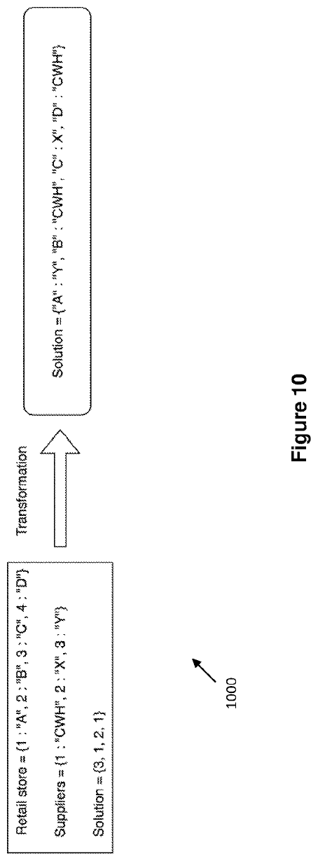

FIG. 10 shows a flowchart 1000 illustrating an input and an output of selecting an optimal set of distribution channels to distribute one or more products in a distribution network of three suppliers (indexed by “CWH”, “X”, “Y) to four retail stores (indexed by “A”, “B”, “C”, “D”) according to an embodiment of the present disclosure. The problem here is to decide using which suppliers or CWH to replenish inventory requests for each of the retail stores under capacity, MOQ and non-partial replenishment constraints. With the required input data file mentioned above, the invention will first perform the necessary data processing with the pre-processing module and then concurrently apply the available solution algorithms with the parallel solver pipeline to generate the solution.

In this embodiment, a solution with an optimal set of distribution channels {3, 1, 2, 1} is the assignment decision represented with suppliers' index numbers, meaning retail store 1 will be served directly by supplier 3 and retail store 2 will be served by central warehouse 1, and so on. The post-processing module will then perform the transformation of the solution, as illustrated in FIG. 10, to {“A”: “Y”; “B”: “CWH”; “C”: “X”; “D”: CWH”} be represented with the suppliers' and retail stores' names or initials. With the transformation, it is straightforward and clear that retail store A will be replenished by supplier Y, retail store B will be replenished from the central warehouse, retail store C will be replenished by supplier X and retail store D will be replenished by the central warehouse. The users can then apply the solution after transformation in practice.

FIG. 11 shows a schematic diagram of a general purpose computer system 1100 upon which the coordination server 208 of FIG. 2 can be practiced. The computer system 1100 includes: a computer module 1101, input devices such as a keyboard 1102, a mouse pointer device 1103, a scanner 1126, a camera 1127, and a microphone 1180; and output devices including a printer 1115, a display device 1114 and loudspeakers 1117. An external Modulator-Demodulator (Modem) transceiver device 1116 may be used by the computer module 1101 for communicating to and from a communications network 1120 via a connection 1121. The communications network 1120 may be a wide-area network (WAN), such as the Internet, a cellular telecommunications network, or a private WAN. Where the connection 1121 is a telephone line, the modem 1116 may be a traditional “dial-up” modem. Alternatively, where the connection 1121 is a high capacity (e.g., cable) connection, the modem 1116 may be a broadband modem. A wireless modem may also be used for wireless connection to the communications network 1120.

The input and output devices may be used by an operator who is interacting with the coordination server 208. For example, the printer 1115 may be used to print reports relating to the status of the coordination server 208.

The coordination server 208 uses the communications network 1120 to communicate with the provider device 204, the requestor device 202, the distribution channel selection server 212 and the database 213 to receive commands and data. The coordination server 208 also uses the communications network 1120 to communicate with the provider device 204, the requestor device 202, the distribution channel selection server 212 and the database 213 to send notification messages or location data, route data, time data, product data, order data, requestor data, provider data and transaction data associated with order requests.

The computer module 1101 typically includes at least one processor unit 1105, and at least one memory unit 1106. For example, the memory unit 1106 may have semiconductor random access memory (RAM) and semiconductor read only memory (ROM). The computer module 1101 also includes a number of input/output (I/O) interfaces including: an audio-video interface 1107 that couples to the video display 1114, loudspeakers 1117 and microphone 1180; an I/O interface 1113 that couples to the keyboard 1102, mouse 1103, scanner 1126, camera 1127 and optionally a joystick or other human interface device (not illustrated); and an interface 1108 for the external modem 1116 and printer 1115. In some implementations, the modem 1116 may be incorporated within the computer module 1101, for example within the interface 1108. The computer module 1101 also has a local network interface 1111, which permits coupling of the computer system 1100 via a connection 1123 to a local-area communications network 1122, known as a Local Area Network (LAN). As illustrated in FIG. 9, the local communications network 1122 may also couple to the wide network 1120 via a connection 1124, which would typically include a so-called “firewall” device or device of similar functionality. The local network interface 1111 may comprise an Ethernet circuit card, a Bluetooth® wireless arrangement or an IEEE 802.11 wireless arrangement; however, numerous other types of interfaces may be practiced for the interface 1111.

The I/O interfaces 1108 and 1113 may afford either or both of serial and parallel connectivity, the former typically being implemented according to the Universal Serial Bus (USB) standards and having corresponding USB connectors (not illustrated). Storage devices 1109 are provided and typically include a hard disk drive (HDD) 1110. Other storage devices such as a floppy disk drive and a magnetic tape drive (not illustrated) may also be used. An optical disk drive 1112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the coordination server 208.

The components 1105 to 1113 of the computer module 1101 typically communicate via an interconnected bus 1104 and in a manner that results in a conventional mode of operation of a computer system known to those in the relevant art. For example, the processor 1105 is coupled to the system bus 1104 using a connection 1118. Likewise, the memory 1106 and optical disk drive 1112 are coupled to the system bus 1104 by connections 1119. Examples of computers on which the described arrangements can be practised include IBM-PC's and compatibles, Sun Sparcstations, Apple Mac™ or like computer systems.

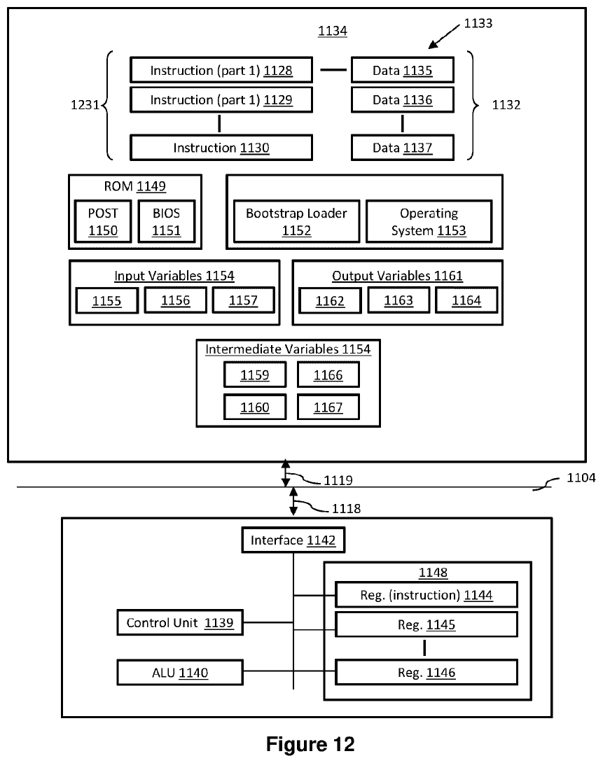

The method of operating the coordination server 208, as shown in the processes of FIG. 5, may be implemented as one or more software application programs 1113 executable within the coordination server 208. In particular, the steps of the processes shown in FIG. 5 are effected by instructions 1131 (see FIG. 12) in the software (i.e., computer program codes) 1133 that are carried out within the coordination server 208. The software instructions 1131 may be formed as one or more code modules, each for performing one or more particular tasks. The software may also be divided into two separate parts, in which a first part and the corresponding code modules performs the operation of the coordination server 208 and a second part and the corresponding code modules manages the API and corresponding user interfaces in the provider device 204, the requestor device 202, and on the display 1114. In other words, the second part of the software manages the interaction between (a) the first part and (b) any one of the provider device 204, the requestor device 202, and the operator of the server 208.

The software may be stored in a computer readable medium, including the storage devices described below, for example. The software is loaded into the coordination server 208 from the computer readable medium, and then executed by the computer system 1100. A computer readable medium having such software or computer program recorded on the computer readable medium is a computer program product. The use of the computer program product in the coordination server 208 preferably effects an advantageous apparatus for receiving/transmitting location data, route data, time data, product data, order data, requestor data, provider data and transaction data associated with order requests for the optimal set of distribution channels election processes performed by the distribution channel selection server 212.

The software (i.e., computer program codes) 1133 is typically stored in the HDD 1110 or the memory 1106. The software 1133 is loaded into the computer system 1100 from a computer readable medium (e.g., the memory 1106), and executed by the processor 1105. Thus, for example, the software 1133 may be stored on an optically readable disk storage medium (e.g., CD-ROM) 1125 that is read by the optical disk drive 1112. A computer readable medium having such software or computer program recorded on it is a computer program product. The use of the computer program product in the coordination server 208 preferably effects an apparatus for receiving/transmitting location data, route data, time data, product data, order data, requestor data, provider data and transaction data associated with order requests for the optimal set of distribution channels election processes performed by the distribution channel selection server 212.

In some instances, the application programs 1133 may be supplied to the user encoded on one or more CD-ROMs 1125 and read via the corresponding drive 1112, or alternatively may be read by the user from the networks 1120 or 1122. Still further, the software can also be loaded into the coordination server 208 from other computer readable media. Computer readable storage media refers to any non-transitory tangible storage medium that provides recorded instructions and/or data to the coordination server 108 for execution and/or processing by the processor 1105. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1101. Examples of transitory or non-tangible computer readable transmission media that may also participate in the provision of software, application programs, instructions and/or data to the computer module 1101 include radio or infra-red transmission channels as well as a network connection to another computer or networked device, and the Internet or Intranets including e-mail transmissions and information recorded on Websites and the like.

The second part of the application programs 1133 and the corresponding code modules mentioned above may be executed to implement one or more API of the coordination server 208 with associated graphical user interfaces (GUIs) to be rendered or otherwise represented upon the display 1114 or the display of the provider device 204 and the requestor device 202. Through manipulation of typically the keyboard 1102 and the mouse 1103, an operator of the server 210 and the application may manipulate the interface in a functionally adaptable manner to provide controlling commands and/or input to the applications associated with the GUI(s). Similarly, on the provider device 204 and the requestor device 202, a user of those devices 202, 204 manipulate the input devices (e.g., touch screen, keyboard, mouse, etc.) of those devices 202, 204 in a functionally adaptable manner to provide controlling commands and/or input to the applications associated with the GUI(s). Other forms of functionally adaptable user interfaces may also be implemented, such as an audio interface utilizing speech prompts output via the loudspeakers 1117 and user voice commands input via the microphone 1180. These other forms of functionally adaptable user interfaces may also be implemented on the provider device 204 and the requestor device 202.

FIG. 12 is a detailed schematic block diagram of the processor 1105 and a “memory” 1134. The memory 1134 represents a logical aggregation of all the memory modules (including the HDD 1109 and semiconductor memory 1106) that can be accessed by the computer module 1101 in FIG. 11.

When the computer module 1101 is initially powered up, a power-on self-test (POST) program 1150 executes. The POST program 1150 is typically stored in a ROM 1149 of the semiconductor memory 1106 of FIG. 11. A hardware device such as the ROM 1149 storing software is sometimes referred to as firmware. The POST program 1150 examines hardware within the computer module 1101 to ensure proper functioning and typically checks the processor 1105, the memory 1134, and a basic input-output systems software (BIOS) module 1151, also typically stored in the ROM 1149, for correct operation. Once the POST program 1150 has run successfully, the BIOS 1151 activates the hard disk drive 1110 of FIG. 12. Activation of the hard disk drive 1110 causes a bootstrap loader program 1152 that is resident on the hard disk drive 1110 to execute via the processor 1105. This loads an operating system 1153 into the RAM memory 1106, upon which the operating system 1153 commences operation. The operating system 1153 is a system level application, executable by the processor 1105, to fulfil various high level functions, including processor management, memory management, device management, storage management, software application interface, and generic user interface.

The operating system 1153 manages the memory 1134 to ensure that each process or application running on the computer module 1101 has sufficient memory in which to execute without colliding with memory allocated to another process. Furthermore, the different types of memory available in the server 208 of FIG. 11 must be used properly so that each process can run effectively. Accordingly, the aggregated memory 1134 is not intended to illustrate how particular segments of memory are allocated (unless otherwise stated), but rather to provide a general view of the memory accessible by the server 208 and how such is used.

As shown in FIG. 12, the processor 1105 includes a number of functional modules including a control unit 1139, an arithmetic logic unit (ALU) 1140, and a local or internal memory 1148, sometimes called a cache memory. The cache memory 1248 typically includes a number of storage registers 1144-1146 in a register section. One or more internal busses 1141 functionally interconnect these functional modules. The processor 1105 typically also has one or more interfaces 1142 for communicating with external devices via the system bus 1104, using a connection 1118. The memory 1134 is coupled to the bus 1104 using a connection 1119.

The application program 1133 includes a sequence of instructions 1131 that may include conditional branch and loop instructions. The program 1133 may also include data 1132 which is used in execution of the program 1133. The instructions 1531 and the data 1132 are stored in memory locations 1128, 1129, 1130 and 1135, 1136, 1137, respectively. Depending upon the relative size of the instructions 1131 and the memory locations 1128-1130, a particular instruction may be stored in a single memory location as depicted by the instruction shown in the memory location 1130. Alternately, an instruction may be segmented into a number of parts each of which is stored in a separate memory location, as depicted by the instruction segments shown in the memory locations 1128 and 1129.

In general, the processor 1105 is given a set of instructions which are executed therein. The processor 1105 waits for a subsequent input, to which the processor 1105 reacts to by executing another set of instructions. Each input may be provided from one or more of a number of sources, including data generated by one or more of the input devices 1102, 1103, data received from an external source across one of the networks 1120, 1102, data retrieved from one of the storage devices 1106, 1109 or data retrieved from a storage medium 1125 inserted into the corresponding reader 1112, all depicted in FIG. 11. The execution of a set of the instructions may in some cases result in output of data. Execution may also involve storing data or variables to the memory 1134.

The disclosed association management and payment initiation arrangements use input variables 1154, which are stored in the memory 1134 in corresponding memory locations 1155, 1156, 1157. The association management and payment initiation arrangements produce output variables 1161, which are stored in the memory 1134 in corresponding memory locations 1162, 1163, 1164. Intermediate variables 1158 may be stored in memory locations11 1160, 1166 and 1167.

Referring to the processor 1105 of FIG. 11, the registers 1144, 1145, 1146, the arithmetic logic unit (ALU) 1140, and the control unit 1139 work together to perform sequences of micro-operations needed to perform “fetch, decode, and execute” cycles for every instruction in the instruction set making up the program 1133. Each fetch, decode, and execute cycle comprises: a fetch operation, which fetches or reads an instruction 1131 from a memory location 1128, 1129, 1130; a decode operation in which the control unit 1139 determines which instruction has been fetched; and an execute operation in which the control unit 1139 and/or the ALU 1140 execute the instruction.

Thereafter, a further fetch, decode, and execute cycle for the next instruction may be executed. Similarly, a store cycle may be performed by which the control unit 1139 stores or writes a value to a memory location 1132.

Each step or sub-process in the processes of FIG. 5 is associated with one or more segments of the program 1133 and is performed by the register section 1144, 1145, 1147, the ALU 1140, and the control unit 1139 in the processor 1105 working together to perform the fetch, decode, and execute cycles for every instruction in the instruction set for the noted segments of the program 1133.

It is to be understood that the structural context of the coordination server 108 is presented merely by way of example. Therefore, in some arrangements, one or more features of the coordination server 108 may be omitted. Also, in some arrangements, one or more features of the coordination server 108 may be combined. Additionally, in some arrangements, one or more features of the coordination server 108 may be split into one or more component parts.

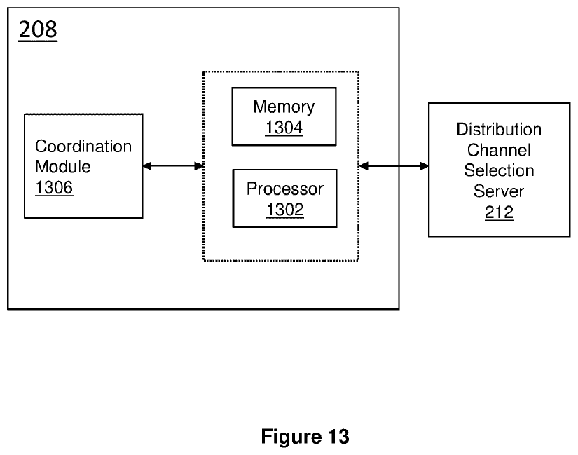

FIG. 13 shows an alternative computer device to implement the coordination server 208 of FIG. 2 (i.e., the computer system 1300). In the alternative implementation, the coordination server 208 may be generally described as a physical device comprising at least one processor 1302 and at least one memory 1304 including computer program codes. The at least one memory 1304 and the computer program codes are configured to, with the at least one processor 1302, cause the coordination server 208 to facilitate the operations described in the processes of FIG. 5. The coordination server 208 may also include a coordination module 1306. The memory 1304 stores computer program code that the processor 1302 compiles to have each of the modules performs their respective functions.

With reference to FIG. 2, the coordination module 1306 performs the function of communicating with the requestor device 202 and the provider device 204; and the acquirer server 206 and the issuer server 210 to respectively receive and transmit a transaction and location/route/vehicle/model data. Further, the coordination module 1306 may provide data and information such as location data, route data, time data, product data, order data, requestor data, provider data and transaction data associated with order requests used for the optimal distribution channels set selection processes by the distribution channel selection server 212.

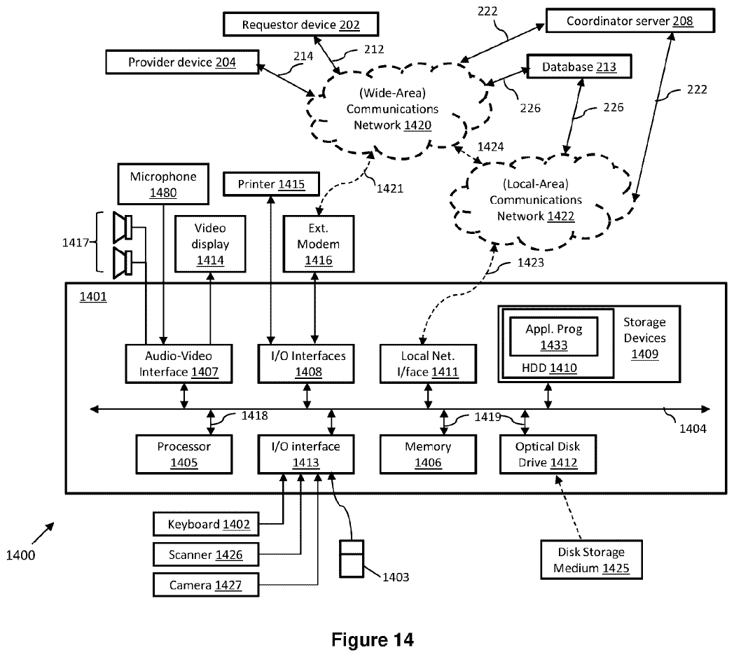

FIG. 14 shows a schematic diagram of a general purpose computer system 1400 upon which the distribution channel selection server 212 of FIG. 2 can be practiced. The computer system 1400 includes: a computer module 1401, input devices such as a keyboard 1402, a mouse pointer device 1403, a scanner 1426, a camera 1427, and a microphone 1480; and output devices including a printer 1415, a display device 1414 and loudspeakers 1417. An external Modulator-Demodulator (Modem) transceiver device 1416 may be used by the computer module 1401 for communicating to and from a communications network 1420 via a connection 1421. The communications network 1420 may be a wide-area network (WAN), such as the Internet, a cellular telecommunications network, or a private WAN. Where the connection 1421 is a telephone line, the modem 1416 may be a traditional “dial-up” modem. Alternatively, where the connection 1421 is a high capacity (e.g., cable) connection, the modem 1413 may be a broadband modem. A wireless modem may also be used for wireless connection to the communications network 1420.

The input and output devices may be used by an operator who is interacting with the distribution channel selection server 212. For example, the printer 1415 may be used to print reports relating to the status of the distribution channel selection server 212.

The distribution channel selection server 212 uses the communications network 1420 to communicate with the provider device 204, the requestor device 202, the coordination server 208 and the database 213 to receive commands and data. The distribution channel selection server 212 also uses the communications network 1420 to communicate with the provider device 204, the requestor device 202, the coordination server 212 and the database 213 to send notification messages or location data, route data, time data, product data, order data, requestor data, provider data and transaction data associated with order requests.

The computer module 1401 typically includes at least one processor unit 1805, and at least one memory unit 1406. For example, the memory unit 1406 may have semiconductor random access memory (RAM) and semiconductor read only memory (ROM). The computer module 1401 also includes a number of input/output (I/O) interfaces including: an audio-video interface 1407 that couples to the video display 1414, loudspeakers 1417 and microphone 1480; an I/O interface 1413 that couples to the keyboard 1402, mouse 1403, scanner 1426, camera 1427 and optionally a joystick or other human interface device (not illustrated); and an interface 1408 for the external modem 1416 and printer 1415. In some implementations, the modem 1416 may be incorporated within the computer module 1401, for example within the interface 1408. The computer module 1401 also has a local network interface 1411, which permits coupling of the computer system 1400 via a connection 1423 to a local-area communications network 1422, known as a Local Area Network (LAN). As illustrated in FIG. 14, the local communications network 1422 may also couple to the wide network 1420 via a connection 1424, which would typically include a so-called “firewall” device or device of similar functionality. The local network interface 1411 may comprise an Ethernet circuit card, a Bluetooth® wireless arrangement or an IEEE 802.11 wireless arrangement; however, numerous other types of interfaces may be practiced for the interface 1411.

The I/O interfaces 1408 and 1413 may afford either or both of serial and parallel connectivity, the former typically being implemented according to the Universal Serial Bus (USB) standards and having corresponding USB connectors (not illustrated). Storage devices 1809 are provided and typically include a hard disk drive (HDD) 1410. Other storage devices such as a floppy disk drive and a magnetic tape drive (not illustrated) may also be used. An optical disk drive 1412 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the distribution channel selection server 212.

The components 1405 to 1413 of the computer module 1801 typically communicate via an interconnected bus 1404 and in a manner that results in a conventional mode of operation of a computer system known to those in the relevant art. For example, the processor 1405 is coupled to the system bus 1404 using a connection 1418. Likewise, the memory 1406 and optical disk drive 1412 are coupled to the system bus 1404 by connections 1419. Examples of computers on which the described arrangements can be practised include IBM-PC's and compatibles, Sun Sparcstations, Apple Mac™ or like computer systems.

The methods of operating the distribution channel selection server 212, as shown in the processes of FIG. 5, may be implemented as one or more software application programs 1433 executable within the distribution channel selection server 212. In particular, the steps of the processes shown in FIG. 5 effected by instructions (see corresponding component 1131 in FIG. 12) in the software (i.e., computer program codes) 1433 that are carried out within the distribution channel selection server 212. The software instructions 1131 may be formed as one or more code modules, each for performing one or more particular tasks. The software may also be divided into two separate parts, in which a first part and the corresponding code modules performs the operation of the distribution channel selection server 212 and a second part and the corresponding code modules manages the API and corresponding user interfaces in the provider device 204, the requestor device 202, and on the display 1414. In other words, the second part of the software manages the interaction between (a) the first part and (b) any one of the provider device 204, the requestor device 202, and the operator of the server 212.

The software may be stored in a computer readable medium, including the storage devices described below, for example. The software is loaded into the distribution channel selection server 212 from the computer readable medium, and then executed by the computer system 1400. A computer readable medium having such software or computer program recorded on the computer readable medium is a computer program product. The use of the computer program product in the distribution channel selection server 212 preferably effects an advantageous apparatus for selecting an optimal set of distribution channels to distribute one or more products from a plurality of suppliers to a plurality of buyers.

The software (i.e., computer program codes) 1433 is typically stored in the HDD 1410 or the memory 1406. The software 1433 is loaded into the computer system 1400 from a computer readable medium (e.g., the memory 1406), and executed by the processor 1405. Thus, for example, the software 1433 may be stored on an optically readable disk storage medium (e.g., CD-ROM) 1425 that is read by the optical disk drive 1412. A computer readable medium having such software or computer program recorded on it is a computer program product. The use of the computer program product in the distribution channel selection server 212 preferably effects an apparatus for selecting an optimal set of distribution channels to distribute one or more products from a plurality of suppliers to a plurality of buyers.

In some instances, the application programs 1433 may be supplied to the user encoded on one or more CD-ROMs 1425 and read via the corresponding drive 1412, or alternatively may be read by the user from the networks 1420 or 1422. Still further, the software can also be loaded into the distribution channel selection server 212 from other computer readable media. Computer readable storage media refers to any non-transitory tangible storage medium that provides recorded instructions and/or data to the distribution channel selection server 212 for execution and/or processing by the processor 1405. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1401. Examples of transitory or non-tangible computer readable transmission media that may also participate in the provision of software, application programs, instructions and/or data to the computer module 1401 include radio or infra-red transmission channels as well as a network connection to another computer or networked device, and the Internet or Intranets including e-mail transmissions and information recorded on Websites and the like.

The second part of the application programs 1433 and the corresponding code modules mentioned above may be executed to implement one or more API of the distribution channel selection server 212 with associated graphical user interfaces (GUIs) to be rendered or otherwise represented upon the display 1814 or the display of the provider device 204 and the requestor device 202. Through manipulation of typically the keyboard 1402 and the mouse 1403, an operator of the server 212 and the application may manipulate the interface in a functionally adaptable manner to provide controlling commands and/or input to the applications associated with the GUI(s). Similarly, on the provider device 204 and the requestor device 202, a user of those devices 202, 204 manipulate the input devices (e.g., touch screen, keyboard, mouse, etc.) of those devices 202, 204 in a functionally adaptable manner to provide controlling commands and/or input to the applications associated with the GUI(s). Other forms of functionally adaptable user interfaces may also be implemented, such as an audio interface utilizing speech prompts output via the loudspeakers 1417 and user voice commands input via the microphone 1480. These other forms of functionally adaptable user interfaces may also be implemented on the provider device 204 and the requestor device 202.

It is to be understood that the structural context of the coordination server 208 is presented merely by way of example. Therefore, in some arrangements, one or more features of the coordination server 208 may be omitted. Also, in some arrangements, one or more features of the distribution channel selection server 212 may be combined. Additionally, in some arrangements, one or more features of the distribution channel selection server 212 may be split into one or more component parts.

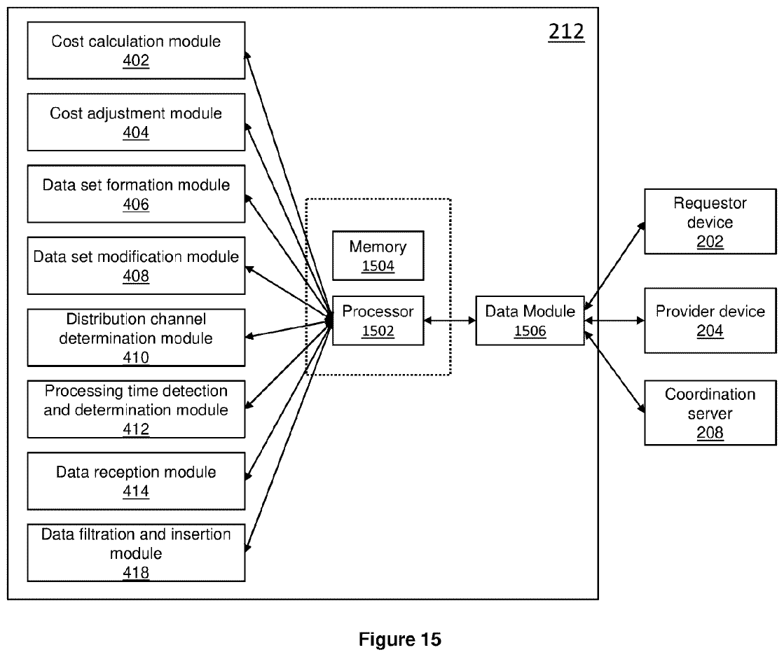

FIG. 15 shows an alternative computer device to implement the distribution channel selection server 212 of FIG. 2. In the alternative implementation, the distribution channel selection server 212 may be generally described as a physical device comprising at least one processor 1502 and at least one memory 1504 including computer program codes. The at least one memory 1504 and the computer program codes are configured to, with the at least one processor 1502, cause the distribution channel selection server 212 of FIG. 2 to perform the operations described in the processes of FIG. 5. The distribution channel selection server 212 may include various modules 402-416 of the system 400 described in FIG. 4. The memory 1504 stores computer program code that the processor 1502 compiles to have each of the modules 402-416 performs their respective functions as described in FIG. 4 and its accompanying description.

The distribution channel selection server 212 may also include a data module 1506 configured to perform the functions of receiving data including location data, route data, time data, product data, order data, requestor data, provider data and transaction data associated with order requests from the requestor device 202, provider device 204, coordination server 208, a cloud and other sources of information to facilitate the processes of FIG. 5. For example, the data module 1506 may be configured to receive a request including location data, route data, time data, product data, order data, requestor data, provider data and transaction data associated with order requests from one user device (such as the requestor device 212 or the provider device 214) the coordination server 208 for use in the optimal distribution channels set selection processes.

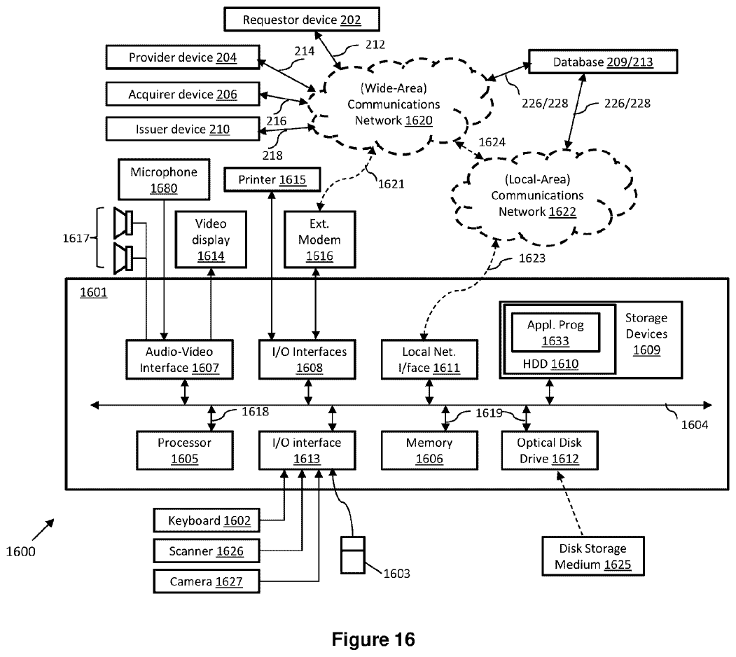

FIG. 16 shows a schematic diagram of a general purpose computer system upon which a combined coordination and distribution channel selection server 208, 212 of FIG. 2 can be practiced. The computer system 1600 includes: a computer module 1601, input devices such as a keyboard 1602, a mouse pointer device 1603, a scanner 1626, a camera 1627, and a microphone 1680; and output devices including a printer 2015, a display device 1614 and loudspeakers 1617. An external Modulator-Demodulator (Modem) transceiver device 1616 may be used by the computer module 1601 for communicating to and from a communications network 1620 via a connection 1621. The communications network 1620 may be a wide-area network (WAN), such as the Internet, a cellular telecommunications network, or a private WAN. Where the connection 1621 is a telephone line, the modem 1616 may be a traditional “dial-up” modem. Alternatively, where the connection 1621 is a high capacity (e.g., cable) connection, the modem 1613 may be a broadband modem. A wireless modem may also be used for wireless connection to the communications network 1620.

The input and output devices may be used by an operator who is interacting with the combined coordination and distribution channel selection server 208, 212. For example, the printer 1615 may be used to print reports relating to the status of the combined coordination and distribution channel selection server 208, 212.

The combined coordination and distribution selection server 208, 212 uses the communications network 1620 to communicate with the provider device 204, the requestor device 202, and the databases 209, 213 to receive commands and data. In one example, the databases 209, 213 may be combined, as shown in FIG. 16. The combined coordination and distribution channel selection server 208, 212 also uses the communications network 1620 to communicate with the provider device 204, the requestor device 202 and the databases 209, 213 to send notification messages or location data, route data, time data, product data, order data, requestor data, provider data and transaction data associated with order requests.

The computer module 1601 typically includes at least one processor unit 1605, and at least one memory unit 1606. For example, the memory unit 1606 may have semiconductor random access memory (RAM) and semiconductor read only memory (ROM). The computer module 1601 also includes a number of input/output (I/O) interfaces including: an audio-video interface 1607 that couples to the video display 1614, loudspeakers 1617 and microphone 1680; an I/O interface 1613 that couples to the keyboard 1602, mouse 1603, scanner 1626, camera 1627 and optionally a joystick or other human interface device (not illustrated); and an interface 1608 for the external modem 1616 and printer 1615. In some implementations, the modem 1616 may be incorporated within the computer module 1601, for example within the interface 1608. The computer module 1601 also has a local network interface 1611, which permits coupling of the computer system 1600 via a connection 1623 to a local-area communications network 1622, known as a Local Area Network (LAN). As illustrated in FIG. 16, the local communications network 1622 may also couple to the wide network 1620 via a connection 1624, which would typically include a so-called “firewall” device or device of similar functionality. The local network interface 1611 may comprise an Ethernet circuit card, a Bluetooth® wireless arrangement or an IEEE 802.11 wireless arrangement; however, numerous other types of interfaces may be practiced for the interface 1611.

The I/O interfaces 1608 and 1613 may afford either or both of serial and parallel connectivity, the former typically being implemented according to the Universal Serial Bus (USB) standards and having corresponding USB connectors (not illustrated). Storage devices 1609 are provided and typically include a hard disk drive (HDD) 1610. Other storage devices such as a floppy disk drive and a magnetic tape drive (not illustrated) may also be used. An optical disk drive 1612 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the combined coordination and distribution channel selection server 208, 212.

The components 1605 to 1613 of the computer module 1601 typically communicate via an interconnected bus 1604 and in a manner that results in a conventional mode of operation of a computer system known to those in the relevant art. For example, the processor 1605 is coupled to the system bus 1604 using a connection 1618. Likewise, the memory 1606 and optical disk drive 1612 are coupled to the system bus 1604 by connections 1619. Examples of computers on which the described arrangements can be practised include IBM-PC's and compatibles, Sun Sparcstations, Apple Mac™ or like computer systems.

The methods of operating the combined coordination and distribution channel selection server 208, 212, as shown in the processes of FIG. 5, may be implemented as one or more software application programs 1633 executable within the combined coordination and distribution channel selection server 208, 212. In particular, the steps of the processes shown in FIGS. 2 and 5-7 are effected by instructions (see corresponding component 1131 in FIG. 12) in the software (i.e., computer program codes) 1633 that are carried out within the combined coordination and distribution channel selection server 208, 212. The software instructions 1131 may be formed as one or more code modules, each for performing one or more particular tasks. The software may also be divided into two separate parts, in which a first part and the corresponding code modules performs the operation of the combined coordination and distribution channel selection server 208, 212 and a second part and the corresponding code modules manages the API and corresponding user interfaces in the provider device 204, the requestor device 202, and on the display 1614. In other words, the second part of the software manages the interaction between (a) the first part and (b) any one of the provider device 204, the requestor device 202, and the operator of the server 212.

The software may be stored in a computer readable medium, including the storage devices described below, for example. The software is loaded into the combined coordination and distribution channel selection server 208, 212 from the computer readable medium, and then executed by the computer system 1600. A computer readable medium having such software or computer program recorded on the computer readable medium is a computer program product. The use of the computer program product in the combined coordination and distribution channel selection server 208, 212 preferably effects an advantageous apparatus for selecting an optimal set of distribution channels to distribute one or more products from a plurality of suppliers to a plurality of buyers as well as for receiving/transmitting data including location data, route data, time data, product data, order data, requestor data, provider data and transaction data associated with order requests used for the optimal distribution channels set selection processes performed by the combined coordination and distribution channel selection server 208, 212.

The software (i.e., computer program codes) 1633 is typically stored in the HDD 1610 or the memory 1606. The software 1633 is loaded into the computer system 1600 from computer readable medium (e.g., the memory 1606), and executed by the processor 1605. Thus, for example, the software 1633 may be stored on an optically readable disk storage medium (e.g., CD-ROM) 1625 that is read by the optical disk drive 1612. A computer readable medium having such software or computer program recorded on it is a computer program product. The use of the computer program product in the combined coordination and distribution channel selection server 208, 212 preferably effects an apparatus for selecting an optimal set of distribution channels to distribute one or more products form a plurality of suppliers to a plurality of buyers as well as for receiving/transmitting data including location data, route data, time data, product data, order data, requestor data, provider data and transaction data associated with order requests used for the optimal distribution channels set selection processes.

In some instances, the application programs 1633 may be supplied to the user encoded on one or more CD-ROMs 1625 and read via the corresponding drive 1612, or alternatively may be read by the user from the networks 1620 or 1622. Still further, the software can also be loaded into the combined coordination and distribution channel selection server 208, 212 from other computer readable media. Computer readable storage media refers to any non-transitory tangible storage medium that provides recorded instructions and/or data to the combined coordination and distribution channel selection server 208, 212 for execution and/or processing by the processor 1605. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 1601. Examples of transitory or non-tangible computer readable transmission media that may also participate in the provision of software, application programs, instructions and/or data to the computer module 1601 include radio or infra-red transmission channels as well as a network connection to another computer or networked device, and the Internet or Intranets including e-mail transmissions and information recorded on Websites and the like.

The second part of the application programs 1633 and the corresponding code modules mentioned above may be executed to implement one or more API of the combined coordination and distribution channel selection server 208, 212 with associated graphical user interfaces (GUIs) to be rendered or otherwise represented upon the display 1614 or the display of the provider device 204 and the requestor device 202. Through manipulation of typically the keyboard 1602 and the mouse 1603, an operator of the server 212 and the application may manipulate the interface in a functionally adaptable manner to provide controlling commands and/or input to the applications associated with the GUI(s). Similarly, on the provider device 204 and the requestor device 202, a user of those devices 202, 204 manipulate the input devices (e.g., touch screen, keyboard, mouse, etc.) of those devices 202, 204 in a functionally adaptable manner to provide controlling commands and/or input to the applications associated with the GUI(s). Other forms of functionally adaptable user interfaces may also be implemented, such as an audio interface utilizing speech prompts output via the loudspeakers 1617 and user voice commands input via the microphone 1680. These other forms of functionally adaptable user interfaces may also be implemented on the provider device 204 and the requestor device 202.

It is to be understood that the structural context of the coordination server 208 is presented merely by way of example. Therefore, in some arrangements, one or more features of the coordination server 208 may be omitted. Also, in some arrangements, one or more features of the combined coordination and distribution channel selection server 208, 212 may be combined. Additionally, in some arrangements, one or more features of the combined coordination and distribution channel selection server 208, 212 may be split into one or more component parts.

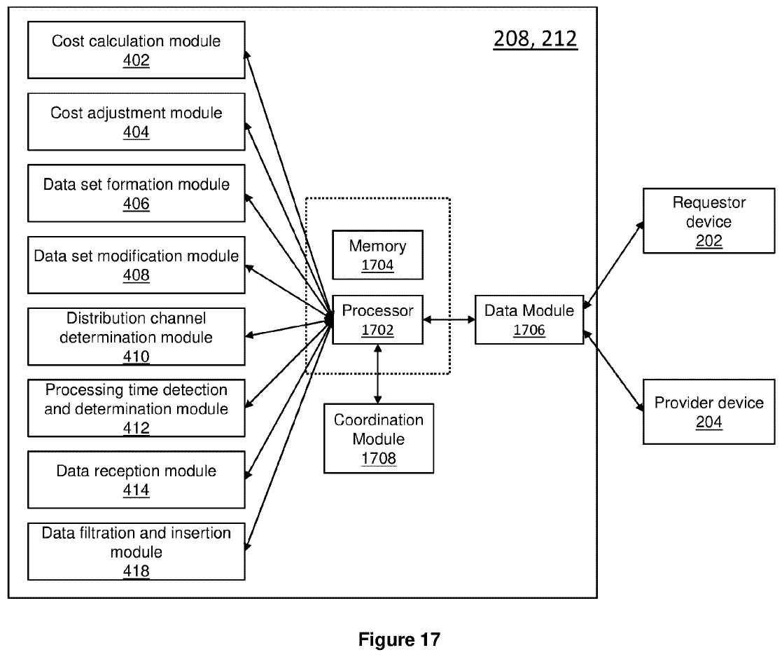

FIG. 17 shows an alternative computer device to implement a combined coordination and distribution channel selection server 208, 212 of FIG. 2. In the alternative implementation, the combined coordination and distribution channel selection server 208, 212 may be generally described as a physical device comprising at least one processor 1702 and at least one memory 1704 including computer program codes. The at least one memory 1704 and the computer program codes are configured to, with the at least one processor 1702, cause the combined coordination and distribution channel selection server 208, 212 to perform the operations described in the processes of FIG. 5. The combined coordination and distribution channel selection server 208, 212 may include various modules 402-416 of the system 400 described in FIG. 4. The memory 1704 stores computer program code that the processor 1702 compiles to have each of the modules 402-416 performs their respective functions as described in FIG. 4 and its accompanying description.

The combined coordination and distribution channel selection server 208, 212 may also include a coordination module 1708 configured to perform the function of communicating with the requestor device 202 and the provider device 204; and the acquirer server 206 and the issuer server 210 to respectively receive and transmit data including location data, route data, time data, product data, order data, requestor data, provider data and transaction data associated with order requests that are used for the optimal distribution channels set selection processes.

The combined coordination and distribution channel selection server 208, 212 may also include a data module 1706 configured to perform the functions of receiving data including location data, route data, time data, product data, order data, requestor data, provider data and transaction data associated with order requests from the requestor device 202, provider device 204, coordination server 208, a cloud and other sources of information to facilitate the processes of FIG. 5. For example, the data module 1706 may be configured to receive a request with data including location data, route data, time data, product data, order data, requestor data, provider data and transaction data associated with order requests from one user device (such as the requestor device 212 or the provider device 214) to perform the optimal distribution channels set selection processes.

The foregoing describes only some embodiments of the present disclosure, and modifications and/or changes can be made thereto without departing from the scope and spirit of the invention, the embodiments being illustrative and not restrictive.

1. A method for selecting an optimal set of distribution channels to distribute one or more products from a plurality of suppliers to a plurality of buyers, comprising:
calculating, by a processor of an apparatus, a distribution cost of each set of distribution channels of a plurality of sets of distribution channels to distribute the one or more products from the plurality of suppliers to the plurality of buyers, wherein at least one of the plurality of suppliers is set to distribute at least one of the one or more products to each of the plurality of buyers in the each set of distribution channels of the plurality of sets of distribution channels; and
adjusting, by the processor, the distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest distribution cost among the plurality of sets of distribution channels is selected as the optimal set of distribution channels to distribute the one or more products from the plurality of suppliers to the plurality of buyers.

2. The method of claim 1, further comprising:
forming, by the processor, a set of data relating to the one or more products, the plurality of buyers and/or the plurality of suppliers received from a data input, wherein the calculation of the distribution cost to distribute the one or more products from the plurality of suppliers to the plurality of buyers is based on the set of data.

3. The method of claim 2, wherein the step of adjusting the distribution cost of the each set of distribution channels of the plurality of sets of distribution channels comprises:
modifying, by the processor, the set of data relating to at least one of the one or more products, at least one of the plurality of buyers and/or at least one of the plurality of suppliers based on the one or more constraints; and
calculating, by the processor, the distribution cost of the each of the set of distribution channels of the plurality of sets of distribution channels based on the modified set of data.

4. The method of claim 1, further comprising:
determining, by the processor, if a distribution channel of the each set of distribution channels is a distribution channel which selection is limited by the one or more constraints, and the adjustment is carried in response to a result of the determination.

5. The method of claim 2, wherein the step of calculating the distribution cost of the each set of distribution channels of the plurality of sets of distribution channels comprises:
calculating, by the processor, a second distribution cost of each second set of distribution channels of a plurality of second sets of distribution channels to distribute the one or more products from the plurality of suppliers to the plurality of buyers based on a different set of data formed by the data input relating to the one or more products, the plurality of buyers and/or the plurality of suppliers, wherein a set of distribution channels having a lowest distribution cost among the plurality of set of distribution channels and the plurality of second sets of distribution channels is selected as the optimal set of distribution channels.

6. The method of claim 5, further comprising:
adjusting, by the processor, the second distribution cost based on the one or more constraints.

7. The method of claim 1, further comprising:
detecting, by the processor, a processing time for calculating and adjusting the distribution costs of the plurality of sets of distribution channels has exceeded a first preconfigured processing time limit; wherein the set of distribution channels having the lowest distribution cost among the plurality of sets of distribution channels is selected as the optimal set of distribution channels to distribute the one or more products from the plurality of suppliers to the plurality of buyers after the detection.

8. The method of claim 7, further comprising:
determining, by the processor, if the processing time for calculating and adjusting the distribution costs of the plurality of sets of distribution channels has exceeded a second preconfigured processing time limit,
in response to a result of the determination:
calculating, by the processor, a further distribution cost of the each set of distribution channels of the plurality of sets of distribution channels to distribute the one or more products from the plurality of suppliers to the plurality of buyers; and adjusting, by the processor, the further distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest further distribution cost among the plurality of sets of distribution channels is selected as the optimal set of distribution channels to distribute the one or more products from the plurality of suppliers to the plurality of buyers.

9. The method of claim 8, wherein the second pre-configured processing time limit is configured such that two or more iterations of the calculation and the adjustment of the further distribution costs of the plurality of sets of distribution channels can be carried out.

10. The method of claim 2, further comprising:
receiving, by the processor, data relating to at least one of a product quantity, a distribution cost of a buyer/supplier, a location, a required delivery time, a distance and a reliability level of a buyer/supplier and a weight parameter to be applied to the data as the data input.

11. The method of claim 10, wherein the step of forming the set of data relating to the one or more products, the plurality of buyers and/or the plurality of suppliers comprises: detecting, by the processor, data relating to a human input error or a false measurement from the data input; and
filtering out, by the processor, the data relating the human input error or the false measurement from the data input; wherein the set of data is formed from the filtered data input.

12. The method of claim 10, further comprising:
detecting, by the processor, missing data in the data input relating to the at least one of the product quantity, the distribution cost of the buyer/supplier, the location, the required delivery time, the distance, the reliability level of a buyer/supplier and the weight parameter to be applied to the data input; and
inserting, by the processor, new data to replace the missing data in the data input, wherein the new data is a pre-set data or a median of existing data in the data input.

13. The method of claim 1, wherein the one or more constraints comprises a constraint relating to a mode to distribute one of the one or more products, a constraint to have the one or more products of one of the plurality of buyers distributed by only one of the plurality of suppliers, a constraint relating to an availability of a one of the plurality of suppliers, a constraint relating to a minimum order requirement of one of the plurality of suppliers, a constraint relating to a delivery capacity of one of the plurality of suppliers.

14. An apparatus for selecting an optimal set of distribution channels to distribute one or more products from a plurality of suppliers to a plurality of buyers, comprising:
at least one processor; and
at least one memory including computer program code;
the at least one memory and the computer program code configured to, with at least one processor, cause the server at least to, comprising:
calculate a distribution cost of each set of distribution channels of a plurality of sets of distribution channels to distribute the one or more products from the plurality of suppliers to the plurality of buyers, wherein at least one of the plurality of suppliers is set to distribute at least one of the one or more products to each of the plurality of buyers in the each set of distribution channels of the plurality of sets of distribution channels; and
adjust the distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest distribution cost among the plurality of sets of distribution channels is selected as the optimal set of distribution channels to distribute the one or more products from the plurality of suppliers to the plurality of buyers.

15. The apparatus of claim 14, wherein the at least one memory and the computer program code configured to, with the at least one processor, cause the server at least to, further:
form a set of data relating to the one or more products, the plurality of buyers and/or the plurality of suppliers received from a data input, wherein the calculation of the distribution cost to distribute the one or more products from the plurality of suppliers to the plurality of buyers is based on the set of data.

16. The apparatus of claim 15, wherein the at least one memory and the computer program code configured to, with the at least one processor, cause the server at least to, further:
modify the set of data relating to at least one of the one or more products, at least one of the plurality of buyers and/or at least one of the plurality of suppliers based on the one or more constraints; and
calculate the distribution cost of the each of the set of distribution channels of the plurality of sets of distribution channels based on the modified set of data.

17. The apparatus of claim 14, wherein the at least one memory and the computer program code configured to, with the at least one processor, cause the server at least to, further:
determine if a distribution channel of the each set of distribution channels is a distribution channel which selection is limited by the one or more constraints, and the adjustment is carried in response to a result of the determination.

18. The apparatus of claim 15, wherein the at least one memory and the computer program code configured to, with the at least one processor, cause the server at least to, further:
calculate a second distribution cost of each second set of distribution channels of a plurality of second sets of distribution channels to distribute the one or more products from the plurality of suppliers to the plurality of buyers based on a different set of data formed by the data input relating to the one or more products, the plurality of buyers and/or the plurality of suppliers, wherein a set of distribution channels having a lowest distribution cost among the plurality of set of distribution channels and the plurality of second sets of distribution channels is selected as the optimal set of distribution channels.

19. The apparatus of claim 18, wherein the at least one memory and the computer program code configured to, with the at least one processor, cause the server at least to, further:
adjust the second distribution cost based on the one or more constraints.

20. The apparatus of claim 18, wherein the at least one memory and the computer program code configured to, with the at least one processor, cause the server at least to, further:
detect, a processing time for calculating and adjusting the distribution costs of the plurality of sets of distribution channels has exceeded a first pre-configured processing time limit; wherein the set of distribution channels having the lowest distribution cost among the plurality of sets of distribution channels is selected as the optimal set of distribution channels to distribute the one or more products from the plurality of suppliers to the plurality of buyers after the detection.

21. The apparatus of claim 20, wherein the at least one memory and the computer program code configured to, with the at least one processor, cause the server at least to, further:
determine if the processing time for calculating and adjusting the distribution costs of the plurality of sets of distribution channels has exceeded a second pre-configured processing time limit;
calculate a further distribution cost of the each set of distribution channels of the plurality of sets of distribution channels to distribute the one or more products from the plurality of suppliers to the plurality of buyers; and
adjust the further distribution cost of the each set of distribution channels of the plurality of sets of distribution channels based on one or more constraints, each of the one or more constraints limiting a selection of a distribution channel for distributing one of the one or more products from one of the plurality of suppliers to one of the plurality of buyers, wherein a set of distribution channels having a lowest further distribution cost among the plurality of sets of distribution channels is selected as the optimal set of distribution channels to distribute the one or more products from the plurality of suppliers to the plurality of buyers.

22. The apparatus of claim 21, wherein the second pre-configured processing time limit is configured such that two or more iterations of the calculation and the adjustment of the second distribution costs of the plurality of sets of distribution channels can be carried out.

23. The apparatus of claim 15, wherein the at least one memory and the computer program code configured to, with the at least one processor, cause the server at least to, further:
receive data relating to at least one of a product quantity, a distribution cost of a buyer/supplier, a location, a required delivery time, a distance and a reliability level of a buyer/supplier and a weight parameter to be applied to the data as the data input.

24. The apparatus of claim 23, wherein the at least one memory and the computer program code configured to, with the at least one processor, cause the server at least to: detect data relating to a human input error or a false measurement from the data input; and
filter out the data relating the human input error or the false measurement from the data input; and
form the set of data relating to the one or more products, the plurality of buyers and/or the plurality of suppliers from the filtered data input.

25. The apparatus of claim 23, wherein the at least one memory and the computer program code configured to, with the at least one processor, cause the server at least to, further:
detect missing data in the data input relating to the at least one of the product quantity, the distribution cost of the buyer/supplier, the location, the required delivery time, the distance, the reliability level of a buyer/supplier and the weight parameter to be applied to the data input; and
insert new data to replace the missing data in the data input, wherein the new data is a pre-set data or a median of existing data in the data input.

26. The apparatus of claim 14, wherein the one or more constraints comprises a constraint relating to a mode to distribute one of the one or more products, a constraint to have the one or more products of one of the plurality of buyers distributed by only one of the plurality of suppliers, a constraint relating to an availability of a one of the plurality of suppliers, a constraint relating to a minimum order requirement of one of the plurality of suppliers, a constraint relating to a delivery capacity of one of the plurality of suppliers.
